(19) United States
(12) Patent Application Publication
(10) Pub. No.: US 2026/0194758 A1
(43) Pub. Date: Jul. 9, 2026

(54) NEAR-TO-EYE DISPLAY APPARATUS

(71) Applicant: GYGES LABS PTE. LTD., Singapore (SG)

(72) Inventors: Zhoucao CHEN, SHENZHEN (CN); Junzhu TANG, SHENZHEN (CN); Zhujun TANG, SHENZHEN (CN); Yingnan ZHAI, SHENZHEN (CN); Dong PU, SHENZHEN (CN); Faqian LI, SHENZHEN (CN); Qiang ZHANG, SHENZHEN (CN); Zhenzhan ZHU, SHENZHEN (CN); Zheng LYU, SHENZHEN (CN)

(21) Appl. No.: 19/439,368

(22) Filed: Jan. 4, 2026

Related U.S. Application Data
(63) Continuation of application No. PCT/CN2025/145732, filed on Dec. 25, 2025.

(30) Foreign Application Priority Data
Jan. 8, 2025 (CN) 202510032919.7
Jan. 8, 2025 (CN) 202520045163.5
Jan. 22, 2025 (CN) 202520152456.3
Jan. 22, 2025 (CN) 202520152486.4

(51) Int. Cl. G02B 27/01; G02C 11/00

(52) U.S. Cl. CPC G02B 27/0176; G02C 11/10; G02B 2027/0178

(57) ABSTRACT

A near-to-eye display apparatus is provided. A frame defines a first cavity. A first limiting portion is connected to the frame and defines a first through hole. A first temple defines a second cavity. A first electrical device is disposed in the second cavity. A second limiting portion is connected to the first temple and defines a second through hole. A second limiting portion is rotatably connected to the first limiting portion. The first through hole is in communication with the first cavity. A first conductive line passes through the first through hole and the second through hole. A second temple defines a third cavity and is rotatably connected to the frame. A second electrical device is disposed in the third cavity. A second conductive line extends laterally along the frame. The second conductive line passes through the first through hole and the second through hole.

### CROSS-REFERENCE TO RELATED APPLICATIONS

This present application is a continuation application of the International patent application No. PCT/CN2025/145732, filed on Dec. 25, 2025, which claims priorities to the Chinese Patent Application No. 202510032919.7, filed on Jan. 8, 2025, the Chinese Patent Application No. 202520045163.5, filed on Jan. 8, 2025, the Chinese Patent Application No. 202520152486.4, filed on Jan. 22, 2025, and the Chinese Patent Application No. 202520152456.3, filed on Jan. 22, 2025, the entire contents of which are hereby incorporated by reference in their entireties.

### TECHNICAL FIELD

The present disclosure relates to the technical field of intelligent wearable devices, and in particular to a near-to-eye display apparatus.

### BACKGROUND

Intelligent wearable devices are capable of performing functions such as health monitoring, motion tracking, information notifications, voice assistants, navigation, and playback control, etc. With the development of technologies like augmented reality (AR), virtual reality (VR), mixed reality (MR), etc., the intelligent wearable devices, such as head-mounted wearable devices, may provide users with immersive digital experiences.

In related art, a connection structure between a spectacle frame and a temple is often involved. During rotation of the temple relative to the frame, internal electrical lines may be often exposed at the connection structure. During long-term user operations, such as rotation for wearing and removal, these internal electrical lines may be prone to damage.

### SUMMARY OF THE DISCLOSURE

A technical solution adopted by the present disclosure is to provide a near-to-eye display apparatus. The near-to-eye display apparatus includes: a frame, a near-to-eye display module, a first limiting portion, a first temple, a first electrical device, a second limiting portion, a first conductive line, a second temple, a second electrical device, and a second conductive line. The frame defines a first cavity. The near-to-eye display module is disposed on the frame. The first limiting portion is connected to the frame and defines a first through hole. The first through hole is in communication with the first cavity. The first temple defines a second cavity. The first electrical device is disposed in the second cavity. The second limiting portion is connected to the first temple and defines a second through hole. The second limiting portion is rotatably connected to the first limiting portion. The second through hole is in communication with the second cavity. The first through hole is in communication with the first cavity. The first conductive line passes through the first through hole and the second through hole. The first conductive line is electrically connected to the near-to-eye display module and the first electrical device. The second temple defines a third cavity and is rotatably connected to the frame. The second electrical device is disposed in the third cavity. The second conductive line extends laterally along the frame. The second conductive line passes through the first through hole and the second through hole. The second conductive line is electrically connected to the second electrical device and the first electrical device.

### BRIEF DESCRIPTION OF THE DRAWINGS

FIG. 1 is an overall schematic structural view of a near-to-eye display module according to some embodiments of the present disclosure.

FIG. 2 is another schematic structural view of the near-to-eye display module according to some embodiments of the present disclosure.

FIG. 3 is still another schematic structural view of the near-to-eye display module according to some embodiments of the present disclosure.

FIG. 4 is a schematic exploded structural view of the near-to-eye display module according to some embodiments of the present disclosure.

FIG. 5 is an overall schematic structural view of a near-to-eye display apparatus according to some embodiments of the present disclosure.

FIG. 6 is a partial schematic exploded structural view of the near-to-eye display apparatus according to some embodiments of the present disclosure.

FIG. 7 is an enlarged schematic view of a region P1 in FIG. 6.

FIG. 8 is yet another schematic structural view of the near-to-eye display module according to some embodiments of the present disclosure.

FIG. 9 is a schematic structural view of a bushing and a first sliding portion of the near-to-eye display module according to some embodiments of the present disclosure.

FIG. 10 is a schematic structural view of an optical module of the near-to-eye display module according to some embodiments of the present disclosure.

FIG. 11 is a schematic exploded structural view of the near-to-eye display apparatus according to some embodiments of the present disclosure.

FIG. 12 is an enlarged schematic view of a region P2 in FIG. 11.

FIG. 13 is another schematic exploded structural view of the near-to-eye display apparatus according to some embodiments of the present disclosure.

FIG. 14 is an enlarged schematic view of a region P3 in FIG. 13.

FIG. 15 is a schematic structural view of a first limiting portion and a rotating shaft of the near-to-eye display apparatus according to some embodiments of the present disclosure.

FIG. 16 is a schematic structural view of a rotating shaft of the near-to-eye display apparatus according to some embodiments of the present disclosure.

FIG. 17 is a schematic block view of an architecture and a network environment of the near-to-eye display apparatus according to some embodiments of the present disclosure.

FIG. 18 is a schematic structural view of a near-to-eye display device according to some embodiments of the present disclosure.

FIG. 19 is a schematic section view of the near-to-eye display device according to some embodiments of the present disclosure.

FIG. 20 is an enlarged schematic view of a structure E in FIG. 19.

FIG. 21 is a schematic structural view of a near-to-eye display mechanism according to some embodiments of the present disclosure.

FIG. 22 is a schematic exploded structural view of the near-to-eye display mechanism according to some embodiments of the present disclosure.

FIG. 23 is a schematic exploded structural view of the near-to-eye display device according to some embodiments of the present disclosure.

FIG. 24 is an enlarged schematic view of a structure B in FIG. 23.

FIG. 25 is a schematic view of a cooperative structure between a first conductive wire and a positioning structure according to some embodiments of the present disclosure.

FIG. 26 is a schematic view of an assembly structure of a device body and a camera module of the near-to-eye display device according to some embodiments of the present disclosure.

FIG. 27 is a schematic exploded structural view of the device body and the camera module of the near-to-eye display device according to some embodiments of the present disclosure.

FIG. 28 is a partial schematic section view of the assembly structure of the device body and the camera module of the near-to-eye display device according to some embodiments of the present disclosure.

FIG. 29 is a schematic view of a semi-open structure of a spectacle frame of the device body of the near-to-eye display device according to some embodiments of the present disclosure.

FIG. 30 is a schematic structural block view of a housing, an image sensing unit, and a second battery of the camera module according to some embodiments of the present disclosure.

FIG. 31 is a schematic structural view of an arrangement of a wearing detection component on a temple according to some embodiments of the present disclosure.

FIG. 32 is a schematic structural block view of connections between a processor and other electrical components according to some embodiments of the present disclosure.

FIG. 33 is a schematic structural block view of connections between the processor, a sensing control chip, and other components according to some embodiments of the present disclosure.

### DETAILED DESCRIPTION

Hereinafter, technical solutions in some embodiments of the present disclosure will be described clearly and completely with reference to the accompanying drawings in the embodiments of the present disclosure. It is obvious that the described embodiments are only a part of the embodiments of the present disclosure, rather than all of the embodiments. All other embodiments obtained by a person of ordinary skill in the art based on the embodiments of the present disclosure without creative efforts shall fall within the scope of protection of the present disclosure.

The terms “first”, “second”, and “third” in the present disclosure are used for descriptive purposes only and are not to be construed as indicating or implying relative importance or implicitly specifying the number of indicated technical features. Thus, features defined with “first”, “second”, or “third” may explicitly or implicitly include at least one such feature. In the description of the present disclosure, “a plurality of” or “multiple” means at least two, such as two, three, etc., unless explicitly and specifically defined otherwise. All directional indications in the embodiments of the present disclosure (such as up, down, left, right, front, back, etc.) are only used to explain the relative positional relationships, motions, etc., between components in a certain posture (as shown in the drawings). In a case where the posture changes, these directional indications change accordingly. In addition, the terms “comprise”, “include”, “have”, and any variations thereof are intended to cover non-exclusive inclusion. For example, a process, method, system, product, or device that includes a series of operations or units is not limited to the listed operations or units; it may optionally include operations or units that are not listed, or may optionally include other operations or units inherent to these processes, methods, products, or devices.

References to “embodiment” herein mean that a particular feature, structure, or characteristic described in connection with the embodiment may be included in at least one embodiment of the present disclosure. The occurrence of this phrase in various places in the specification does not necessarily all refer to the same embodiment, nor are they independent or alternative embodiments mutually exclusive to other embodiments. Those skilled in the art will understand explicitly and implicitly that the embodiments described herein may be combined with other embodiments.

Furthermore, it is to be understood that the use of the term “substantially” herein, unless otherwise defined with respect to a specific context, with respect to a numeric quantity or otherwise quantifiable relationship, e.g., perpendicularity or parallelism, is to be understood as indicating that quantity +−10%. Thus, for example, lines that are substantially perpendicular to one another may be at angles between 81° and 99° to one another. In a further example, dimensions that are substantially between 1 mm and 3 mm, for example, may range from 0.9 mm to 3.3 mm. In another example, an angle that is substantially in the range of 1 to 1.1 radians may be between 0.9 radians and 1.21 radians.

Hereinafter, the present disclosure will be explained in detail with reference to the accompanying drawings and embodiments.

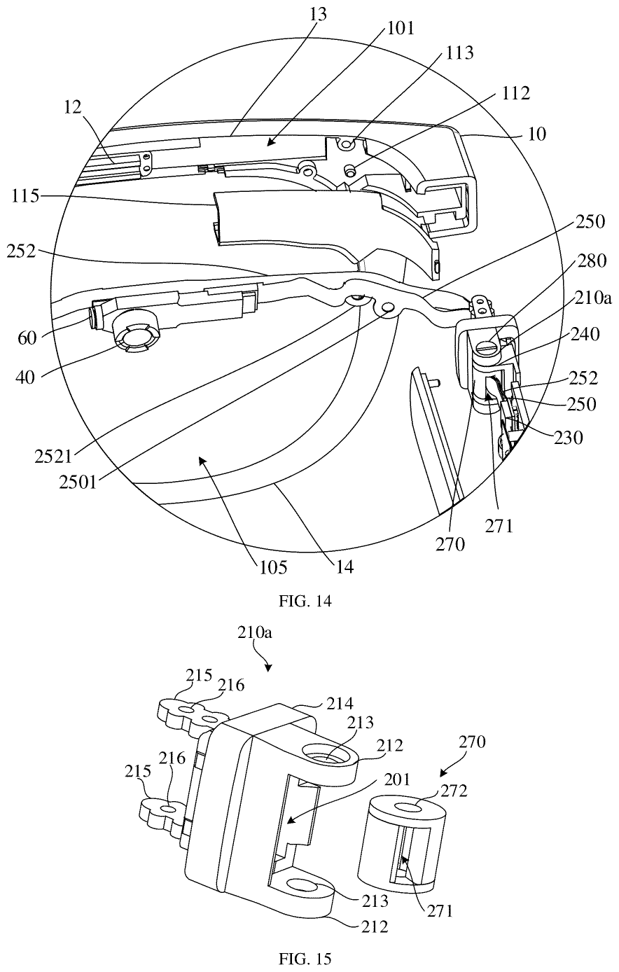

As shown in FIGS. 1-17, some embodiments of the present disclosure may provide a near-to-eye display module 100a. The near-to-eye display module 100a may be applied to a frame 10. The frame 10 may be glasses, a near-to-eye display apparatus 200a, a helmet, or a part of a similar head-mounted device. The frame 10 may be assembled together with the near-to-eye display module 100a as an integral structure or as two independent components onto the above-mentioned exemplary devices or equipment. The frame 10 and the near-to-eye display module 100a may be movably connected to each other. A first housing 20 may be fixed to the frame 10 in a detachable manner or a releasable manner. The near-to-eye display module 100a may include the first housing 20, a micro-display assembly 30, a first sliding portion 50, and a damping rotation mechanism 60. The first housing 20 may be made of plastic or metal. The first housing 20 may define a first accommodating cavity 21. The micro-display assembly 30 may be disposed or accommodated in the first accommodating cavity 21. The micro-display assembly 30 may be configured to generate light. An optical element 40 may be disposed on the first housing 20 and located at a light-emitting side of the micro-display assembly 30. The optical element 40 may be made of polymethyl methacrylate (PMMA), polycarbonate (PC) plastic, glass, resin, or other materials. The light from the micro-display assembly 30 may be configured to enter the optical element 40 from a first end of the optical element 40 and exit from a second end of the optical element 40, where the first end and the second end are two opposite ends of the optical element 40. As shown in FIGS. 1-3, the light from the micro-display assembly 30 may be configured to exit along an optical axis O of the optical element 40. The light from the micro-display assembly 30 may be configured to exit from the optical element 40 after being reflected multiple times within the optical element 40. In some other embodiments, the light from the micro-display assembly 30 may be configured to exit from the optical element 40 after being refracted and reflected within the optical element 40. The light from the micro-display assembly 30 may be configured to present digital content to a human eye after exiting from the optical element 40.

The first sliding portion 50 may be located at one side of the first housing 20. The first sliding portion 50 may be configured to be connected to a second sliding portion 12 of the frame 10. The first sliding portion 50 may be located at a lateral side of the first housing 20 or a bottom side of the first housing 20. The first sliding portion 50 being located at one side of the first housing 20 may be construed as a positional relationship of the first sliding portion 50 relative to the first housing 20. A connection relationship between the first sliding portion 50 and the first housing 20 may include: the first sliding portion 50 being directly connected to the first housing 20 or the first sliding portion 50 being indirectly connected to the first housing 20. One of the first sliding portion 50 and the second sliding portion 12 may include a protrusion. The other one of the first sliding portion 50 and the second sliding portion 12 may include a groove. The protrusion and the groove may be configured to cooperate with each other to enable or allow a relative sliding or movement between the first sliding portion 50 and the second sliding portion 12. In some embodiments, the first sliding portion 50 and the second sliding portion 12 may each be defined with a length extending along a predetermined direction. In some embodiments, the relative movement between the first sliding portion 50 and the second sliding portion 12 may further include, for example, a rolling between cooperating balls or a rolling between meshing gears.

The damping rotation mechanism 60 may be disposed between the first housing 20 and the first sliding portion 50. The damping rotation mechanism 60 may be rotatably connected to the first housing 20. The first housing 20 may be configured to perform a damping rotation relative to the frame 10 through the damping rotation mechanism 60 and to enable the optical element 40 to maintain emitting light at an expected fixed angle relative to the frame 10. Taking the frame 10 of the near-to-eye display apparatus 200a as an example, the light may be emitted at the expected fixed angle along an up-down direction corresponding to eyes of a user wearing the near-to-eye display apparatus 200a. It may be understood that the damping rotation mechanism 60 may be closely connected to the first housing 20, and a rotation between the damping rotation mechanism 60 and the first housing 20 may be allowed. The damping rotation mechanism 60 and the first housing 20 may be rotated relative to each other by an external force. For example, the user may rotate the first housing 20 relative to the damping rotation mechanism 60 using a hand or a tool. The fitting between the damping rotation mechanism 60 and the first housing 20 may provide a preload force. In a case where the first housing 20 is rotated relative to the frame 10 to the user's expected angle, the micro-display assembly 30 and the optical element 40 disposed on the first housing 20 may be synchronously rotated. Further, the micro-display assembly 30 and the optical element 40 may follow along with the first housing 20 and be maintained and fixed at the expected rotation angle, thereby enabling the optical element 40 to emit light at the user's expected rotation angle and realizing a light-emitting angle adjustment that meets a user expectation.

The first sliding portion 50 may be configured to move relative to the second sliding portion 12, driving the damping rotation mechanism 60 and the first housing 20 to synchronously move relative to the frame 10, and further maintaining the optical element 40 at an expected fixed lateral position relative to the frame 10. The lateral position may be along an extending direction of the first sliding portion 50 or the second sliding portion 12. Taking the frame 10 of the near-to-eye display apparatus 200a as an example, the lateral position may be along a direction from a left eye to a right eye of the user wearing the near-to-eye display apparatus 200a. It may be understood that the relative movement or sliding may be performed under an external force. For example, the user may laterally move the first housing 20 using the hand or the tool. The first sliding portion 50 may be configured to move relative to the second sliding portion 12 of the frame 10, further driving the damping rotation mechanism 60 connected to the first housing 20 to synchronously move relative to the frame 10. In this case, the micro-display assembly 30 and the optical element 40 disposed on the first housing 20 may be synchronously moved. The first sliding portion 50 and the second sliding portion 12 may maintain a tight or close cooperation with each other. The micro-display assembly 30 and the optical element 40 may further follow along with the first housing 20 and be maintained and fixed at the lateral position that is expected to be moved to. The lateral position may be defined along a central rotation axis A of the damping rotation mechanism 60, or may be defined along the extending direction of the first sliding portion 50, thereby enabling the optical element 40 to emit light at the lateral position expected to be moved to by the user and realizing a lateral light-emitting position adjustment that meets a user expectation.

Through the above manner, after the near-to-eye display module 100a is disposed on or assembled to the frame 10 of the near-to-eye display apparatus 200a, or in a case where the near-to-eye display module 100a is worn on the human eye, a lateral field-of-view angle adjustment of the optical element 40 may be realized through the first sliding portion 50 and the second sliding portion 12, and a vertical field-of-view angle adjustment of the optical element 40 may be realized through the damping rotation mechanism 60, thereby enabling different users to clearly view content within their respective fields of view. In addition, the movement of the first sliding portion 50 may further drive the damping rotation mechanism 60, the first housing 20, the micro-display assembly 30, and the optical element 40 to synchronously move relative to the frame 10, effectively improving stability during movement of the overall components. Besides, the damping rotation mechanism 60 may be ensured to be capable of rotating at every lateral position during movement, thereby effectively improving accuracy of the field-of-view angle adjustment.

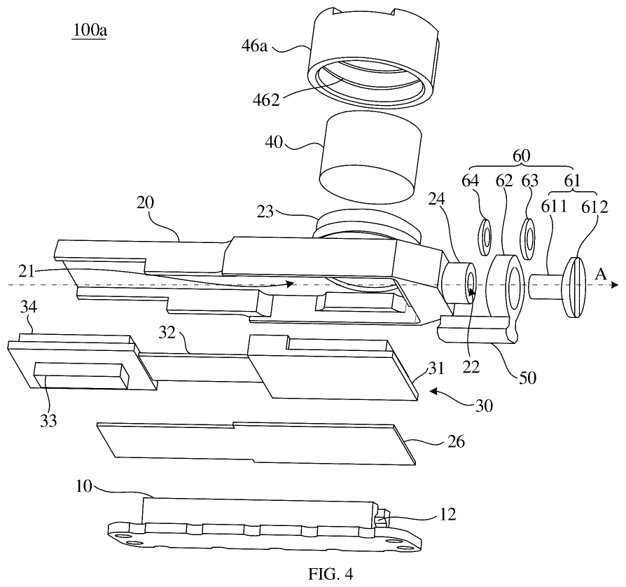

In some embodiments, as shown in FIG. 1 and FIG. 4, the central rotation axis A of the damping rotation mechanism 60 may be substantially parallel to a plane at which the micro-display assembly 30 is located. It may be understood that an overall structure or a main body portion of the micro-display assembly 30 may be substantially planar. For example, a micro display 31 of the micro-display assembly 30 may be substantially planar-shaped or plate-shaped. In this way, taking a plane of the micro-display assembly 30 itself or a plane at which the micro-display assembly 30 is located as a reference, a direction of the central rotation axis A may be described as a lateral direction in some embodiments. The central rotation axis A of the damping rotation mechanism 60 being substantially parallel to the plane at which the micro-display assembly 30 is located, may ensure that the micro-display assembly 30 as a whole or the main body portion of the micro-display assembly 30, i.e., the micro display 31, remains relatively fixed during rotation, thereby reducing a risk of positional deviation of the micro-display assembly 30 during rotation. The first sliding portion 50 may be located at a side of the first housing 20 away from the optical element 40, effectively reducing an impact on width caused by the first sliding portion 50 being located on a lateral side of the first housing 20. Accordingly, in a case where the near-to-eye display module 100a is assembled to the frame 10, for example, to the frame 10 of the near-to-eye display apparatus 200a, a width of the frame 10 may be effectively reduced, which facilitates a concealed design of the near-to-eye display module 100a. The first sliding portion 50 may extend along the direction of the central rotation axis A of the damping rotation mechanism 60. An extending length of the first sliding portion 50 may be smaller than a length of the micro-display assembly 30, which effectively reduces material and weight of the first sliding portion 50, thereby further effectively reducing an overall weight of the near-to-eye display module 100a and facilitating a lightweight design when the near-to-eye display module 100a is assembled to the frame 10.

In some embodiments, as shown in FIGS. 1-4, a first hole 22 may be defined on the first housing 20. The damping rotation mechanism 60 may include a locking member 61 and a bushing 62. A line connecting a central axial direction of the locking member 61 and a central axial direction of the first hole 22 may correspond to the direction of the central rotation axis A. The rotation axis of the damping rotation mechanism 60 may be located at the locking member 61. The locking member 61 may be configured to insert or penetrate through the bushing 62 and to be fixed in the first hole 22. The locking member 61 may be a screw, a bolt, or a stud. An external thread may be formed on the locking member 61, and an internal thread may be formed on an inner wall of the first hole 22. The locking member 61 and the first hole 22 may be connected to each other through a threaded engagement. In some other embodiments, the locking member 61 and the first hole 22 may be connected to each other through an interference fit. For example, a shaft of the locking member 61 may be elastically deformed after being inserted into the first hole 22 to achieve a damping connection. In still some other embodiments, the locking member 61 may be a pin structure inserted into the first hole 22, where damping materials such as a rubber ring or a damping coating, etc., may be provided on mating surfaces to achieve a damping rotation. In still some other embodiments, a key connection, an adhesive bonding, or the like may be formed between the locking member 61 and the first hole 22 to achieve the damping rotation. The first sliding portion 50 may be connected to an outer periphery of the bushing 62. The first sliding portion 50 may extend in a direction away from the locking member 61. It may be understood that, in a case where the first sliding portion 50 is connected to the locking member 61, the first sliding portion 50 may drive the entire damping rotation mechanism 60 to move along the direction of the central rotation axis A, that is, move laterally. Further, in a case where the first sliding portion 50 is connected to the second sliding portion 12, the first sliding portion 50 may be circumferentially fixed and supported, thereby enabling the first housing 20 to rotate relative to the frame 10 through the damping rotation mechanism 60. For example, the user may rotate the first housing 20 by hand, or using an external fixture, etc., thereby further driving the optical element 40 to rotate synchronously and adjusting light to be emitted at the expected fixed angle.

In some embodiments, as further shown in FIGS. 1-4, the damping rotation mechanism 60 may further include a first spacer 63 and a second spacer 64. The locking member 61 may be configured to insert or penetrate through the bushing 62, the first spacer 63, and the second spacer 64 and to be fixed in the first hole 22. The first spacer 63 and the second spacer 64 may be made of rubber, plastic, metal, composite material, and the like. The two spacers may ensure a secure fixation of the locking member 61 and the first hole 22, effectively improving a damping effect during rotation, and reducing excessive looseness during rotation of the damping rotation mechanism 60 that may cause the first housing 20 to be unable to maintain the expected fixed rotation position. That is, after the user rotates the first housing 20 to the expected angle, due to the damping force, the first housing 20 may be maintained at the position of the expected angle, thereby ultimately ensuring that the optical element 40 emits light at the expected angle stably.

In some embodiments, as shown in FIG. 4, the first spacer 63 and the second spacer 64 may be respectively located at two sides of the bushing 62. That is, the bushing 62 may be clamped by the first spacer 63 and the second spacer 64. The locking member 61 may include a threaded shaft portion 611 and a head portion 612 that is slotted, cross-shaped, or the like. The first spacer 63, the second spacer 64, and the bushing 62 may be sleeved on the shaft portion 611. The shaft portion 611 may be fixed in the first hole 22 through rotating the head portion 612. One of the first spacer 63 and the second spacer 64 may be located between the head portion 612 of the locking member 61 and the bushing 62. The other one of the first spacer 63 and the second spacer 64 may be located between the bushing 62 and the first housing 20.

In some other embodiments, the first spacer 63 and the second spacer 64 may be both located at the same side of the bushing 62. The first spacer 63, the second spacer 64, and the bushing 62 may be sleeved on the shaft portion 611. Both the first spacer 63 and the second spacer 64 may be located between the head portion 612 and the bushing 62, or both the first spacer 63 and the second spacer 64 may be located between the first housing 20 and the bushing 62.

In some embodiments, a protruding portion 24 may be further disposed on the first housing 20. The protruding portion 24 may protrude relative to a side surface of the first housing 20. The protruding portion 24 may be substantially cylindrical. The first hole 22 with the thread may be defined in protruding portion 24. The bushing 62 may be at least partially sleeved on the protruding portion 24. It may be understood that the protruding portion 24 may effectively reduce a length of the shaft portion 611 of the locking member 61. The bushing 62 may be sleeved on the protruding portion 24 and the shaft portion 611 may be pressed by the head portion 612 of the fastener 61 to be fixed in the first hole 22. In some other embodiments, a part of the bushing 62 may be sleeved on the protruding portion 24 and another part of the bushing 62 may be sleeved on the shaft portion 611 and fixed on the first hole 22. In still some other embodiments, for the first spacer 63 and the second spacer 64, the first spacer 63, the second spacer 64, and the bushing 62 may all be sleeved on the protruding portion 24. Alternatively, a part of the first spacer 63, the second spacer 64, and the bushing 62 may be sleeved on the protruding portion 24. Another part of the first spacer 63, the second spacer 64, and the bushing 62 may be sleeved on the shaft portion 611. The extending length of the first sliding portion 50 may be smaller than a radial size, i.e., diameter, of the optical element 40, thereby effectively reducing the length of the first sliding portion 50 and reducing overall weight.

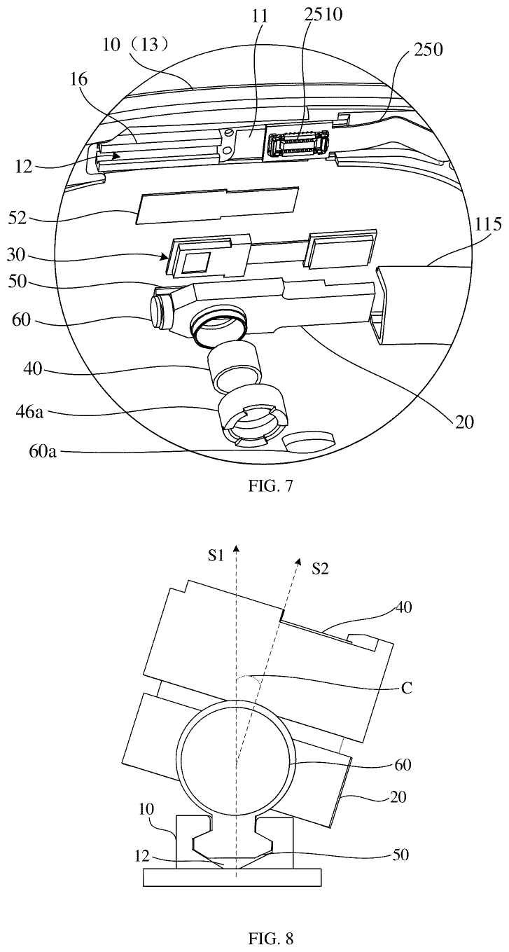

In some embodiments, as shown in FIG. 4, the micro-display assembly 30 may include the micro display 31, a third conductive line 32, and a first electrical interface 33 that are electrically connected to each other. The micro display 31 may be aligned with the optical element 40. The micro display 31 may include, but is not limited to, a micro light-emitting diode (Micro-LED), a micro organic light-emitting diode (Micro-OLED), a liquid crystal on silicon (LCoS), a liquid crystal display (LCD), a digital micromirror device (DMD)/a digital light processing (DLP), or a laser beam scanning (LBS), etc., or any combination of these technologies. The third conductive line 32 may be connected between the micro display 31 and the first electrical interface 33. The third conductive line 32 may be a flexible electrical board. The damping rotation mechanism 60 and the first sliding portion 50 may be both located at a side of the first housing 20 close to the micro display 31 and away from the first electrical interface 33, thereby reducing a positional interference between the first sliding portion 50 and the first electrical interface 33 during movement and rotation, which facilitates in assembling the near-to-eye display module 100a to the frame 10 and allows for rotation and movement operations of the near-to-eye display module 100a. As shown in FIG. 4 and FIG. 7, the micro display 31 and the third conductive line 32 may be electrically connected to a second electrical interface 2510 through the first electrical interface 33. The second electrical interface 2510 may be located in a first cavity 101 of the frame 10. The second electrical interface 2510 may be further electrically connected through a first conductive line 250 to a first electrical device 230 (such as a processor 2301) disposed on a first temple 220a. In some embodiments, a reinforcing plate or a buffer chip 34 may further be disposed on a back of the first electrical interface 33. The micro display 31, the third conductive line 32, and the first electrical interface 33 may be sealed and connected to the first housing 20. As shown in FIG. 4, a cover plate 26 may be further disposed on the first housing 20. The cover plate 26 may be sealed and connected to the first housing 20 so as to seal the micro display 31 and the third conductive line 32 in the first accommodating cavity 21. Alternatively, an opening may be defined on the cover plate 26 at a position corresponding to the first electrical interface 33, thereby allowing for an electrical connection between the first electrical interface 33 and the second electrical interface 2510. In some other embodiments, the cover plate 26 may be omitted. In a case where the first electrical interface 33 is electrically connected to the second electrical interface 2510, an encapsulating adhesive sealing manner may be adopted to encapsulate and seal the micro display 31, the third conductive line 32, the first electrical interface 33, and the second electrical interface 2510. Through sealingly connecting the micro display 31, the third conductive line 32, and the first electrical interface 33 to the first housing 20, a waterproof performance of the near-to-eye display module 100a may be effectively improved, and a risk of sweat or rainwater infiltration during wearing may be reduced. In some embodiments, the extending length of the first sliding portion 50 may be smaller than the length of the micro display 31, thereby reducing a size of the first sliding portion 50 and reducing overall weight.

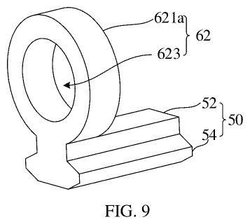

As shown in FIG. 9, the bushing 62 may include an annular main body 621a and a second hole 623 defined in the annular main body 621a. The shaft portion 611 may be configured to insert through the second hole 623. The first sliding portion 50 may include a connecting portion 52 and an outer edge portion 54. The connecting portion 52 may be connected to an outer periphery of the annular main body 621a, for example, tangentially connected to the annular main body 621a. The outer edge portion 54 may be connected to the connecting portion 52. A width of the outer edge portion 54 in a direction away from the annular main body 621a may be greater than a width of the connecting portion 52. The second sliding portion 12 may define a groove whose shape is consistent with a shape of the first sliding portion 50. The connecting portion 52 and the outer edge portion 54 may be tightly fitted and snapped into the groove, thereby achieving a positional fixation during sliding.

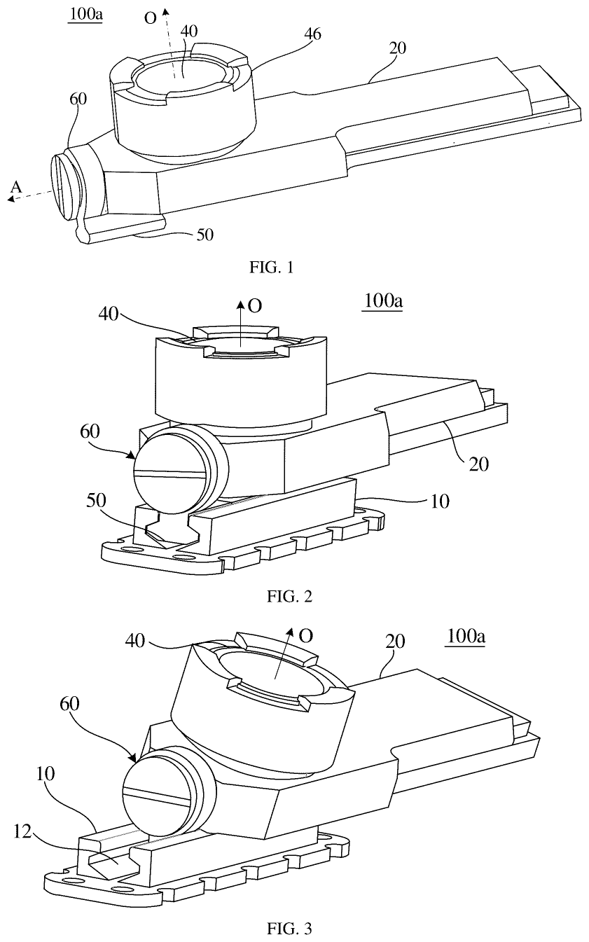

In some embodiments, as shown in FIG. 2, FIG. 3, and FIG. 8, the near-to-eye display module 100a may further define a first center plane S1 that passes through the central rotation axis A of the damping rotation mechanism 60 and through the frame 10. For example, the frame 10 of the first housing 20 may have a bottom plane, and the first center plane S1 may be substantially perpendicular to the bottom plane. Alternatively, the first center plane S1 may substantially be a symmetrical center plane of the frame 10. For example, the second sliding portion 12 may define grooves on two sides, and the grooves on the two sides may be substantially symmetrical with respect to the first center plane S1. The optical element 40 may define a second center plane S2. An overall structure of the optical element 40 may be substantially symmetrical with respect to the second center plane S2. In some embodiments, the second center plane S2 may further be a center of the first housing 20. The second center plane S2 may further be a plane passing through the optical axis O. It may be understood that introduction of the above center planes is merely for convenience of describing a relative rotational relationship between the optical element 40 and the frame 10, and in other embodiments, describing the relative rotational relationship between the optical element 40 and the frame 10 directly or indirectly by referring to other reference systems (such as a reference plane or a reference center) should still fall within a protection scope of a rotation angle of the present disclosure. A rotation angle C of the second center plane S2 relative to the first center plane S1 may be 0-25°, such as 0°, 5°, 10°, 13°, 15°, 20°, 25°, or etc., although an actual rotation angle is not limited to the above values and may be varied by the user according to an actual requirement. FIG. 2 is a schematic view illustrating that the first housing 20 drives the optical element 40 to rotate to a first position, where the rotation angle C of the second center plane S2 relative to the first center plane S1 is substantially 0°. In this case, the first center plane S1 and the second center plane S2 may substantially coincide with each other. In a case where the frame 10 and the first housing 20 are both planar, the frame 10 and the first housing 20 may be substantially parallel to each other, or the optical element 40 may be substantially parallel to the frame 10. FIG. 8 is a schematic view illustrating that the first housing 20 drives the optical element 40 to rotate to a second position, where the rotation angle C of the second center plane S2 relative to the first center plane S1 is not 0°.

In some embodiments, as shown in FIG. 2 and FIG. 3, a moving distance of the first housing 20 relative to the frame 10 is 0-1 cm, such as 0 cm, 0.1 cm, 0.2 cm, 0.4 cm, 0.5 cm, 0.7 cm, 0.8 cm, 0.9 cm, 1 cm, or the like. An actual moving distance is not limited to the above values and may be varied by the user according to the actual requirement. Since the micro display 31 and the optical element 40 are disposed on the first housing 20, the first housing 20 may drive the micro display 31 and the optical element 40 to move synchronously, thereby achieving lateral light emission at different positions. As shown in FIG. 2, the position may be understood as an initial position, where the moving distance is 0 cm. FIG. 3 is a schematic view illustrating that the moving distance of the first housing 20 relative to the frame 10 is greater than 0 cm. FIG. 3 may further illustrate that the first housing 20 drives the optical element 40 to rotate relative to the frame 10 by an angle greater than 0°. It may be understood that the movement and rotation of the near-to-eye display module 100a in some embodiments of the present disclosure may be performed separately. The rotation may be allowed to perform during the movement or the movement may be allowed to perform during the rotation. The damping rotation mechanism 60 may be allowed to be integrally moved at the lateral position, thereby effectively improving flexibility and accuracy of a light-emitting angle of the near-to-eye display module 100a, and effectively reducing interference and damage to the device during movement and operation.

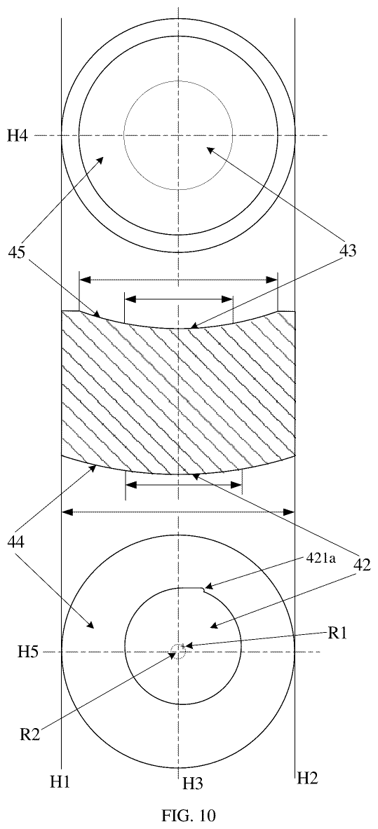

In some embodiments, as shown in FIG. 10, the optical element 40 may further include a light incident surface 42, a first reflective surface 43, a second reflective surface 44, and a light exit surface 45. The light incident surface 42 may be located at the first end of the optical element 40. The first reflective surface 43 may be located at the second end of the optical element 40 opposite to the first end. The second reflective surface 44 may be located at the first end and may surround the light incident surface 42. The light exit surface 45 may be located at the second end and may surround the first reflective surface 43. The micro-display assembly 30 may face toward the light incident surface 42. A second optical element 60a may face toward the light exit surface 45. The optical element 40 may be a solid substrate structure made of a transparent or translucent material. The light incident surface 42 and the second reflective surface 44 may be located at the first end of the solid substrate. The first reflective surface 43 and the light exit surface 45 may be located at the second end of the solid substrate. In some embodiments, the optical element 40 may be a hollow structure. For example, a hollow structure may be defined between the first end and the second end. It may be understood that reflective coatings may be formed on the first reflective surface 43 and the second reflective surface 44, such as metal or metal alloy reflective coatings of silver, aluminum, or the like. The micro-display 30 may face toward the light incident surface 42. The second optical element 60a may face toward the light exit surface 45. Light generated from the micro display 31 may enter through the light incident surface 42, may be projected onto the first reflective surface 43, then may be reflected by the first reflective surface 43 to the second reflective surface 44, and finally may exit through the light exit surface 45. The first reflective surface 43 and the second reflective surface 44 may include one or a combination of an inclined plane, a curved surface, a spherical surface, an aspherical surface, or a free-form surface. The light incident surface 42 and the light exit surface 45 may include one or a combination of a planar surface, a curved surface, a spherical surface, an aspherical surface, or a free-form surface.

In some embodiments, the first reflective surface 43 and the light exit surface 45 may be continuous surfaces, and the light incident surface 42 and the second reflective surface 44 may be continuous surfaces. The continuous surfaces may be understood as being constructed using the same function, for example, both being free-form surfaces constructed by the same Zernike polynomial function. In some embodiments, a surface formed by the first reflective surface 43 and the light exit surface 45, and a surface formed by the light incident surface 42 and the second reflective surface 44 may both be constructed by the same function, and the two surfaces may be substantially parallel to each other. In some embodiments, the surface formed by the first reflective surface 43 and the light exit surface 45, and the surface formed by the light incident surface 42 and the second reflective surface 44 may be both free-form surfaces.

In some embodiments, shapes of the light incident surface 42 and the first reflective surface 43 may both substantially be circular, elliptical, polygonal, or the like. Shapes of the second reflective surface 44 and the light exit surface 45 may both substantially be polygonal, circular, elliptical, closed shapes formed by arcs and straight edges, or the like. In some embodiments, the light incident surface 42 may be the same as or similar to the first reflective surface 43. In some embodiments, an area of the first reflective surface 43 may be greater than or equal to an area of the light incident surface 42. The area of the light incident surface 42 may be greater than or equal to an area of a light-generating region of the micro-display 30, thereby ensuring that the light generated from the micro-display 30 is able to completely enter and be sufficiently reflected and then exit through the light exit surface 45.

In some application scenarios, the optical element 40 as a whole may substantially be a column, such as a cylinder or an elliptical cylinder. During product assembly, it is often difficult to distinguish an accurate orientation of the optical element 40, which may cause assembly errors. Thus, as shown in FIG. 10, some embodiments of the present disclosure may provide a chamfer 421a on an outer periphery of the light incident surface 42. The chamfer 421a may substantially be a straight-edge shape, a prismatic shape, a triangular shape, a polygonal shape, or the like. It may be understood that H1 and H2 constitute an overall lateral size of the optical element 40, an intersection point of H3 and H4 is a center of the first reflective surface 43, and an intersection point of H3 and H5 is a center R2 of the second reflective surface 44. The light incident surface 42 may be eccentrically arranged relative to the second reflective surface 44. A centroid R1 of the light incident surface 42 may be eccentrically arranged relative to the center R2 of the second reflective surface 44 with a preset eccentric distance. The eccentric distance may be 0.1 mm, 0.15 mm, 0.2 mm, or the like. The straight-edge chamfer 421a and/or the eccentric arrangement may facilitate identifying an orientation and a direction of the optical element 40, that is, identifying an orientation of an orthographic projection surface of the optical element 40. For example, the first end or the second end of the optical element 40 may be identified, or the optical element 40 may be identified to be rotated. For example, during assembly, machine vision or the like may be adopted to perform positioning or orientation detection and identification of the optical element 40, which facilitates positioning and mounting of an optical module 330 relative to the micro display 31, thereby ensuring an accurate overall assembly.

In some embodiments, the light incident surface 42, the first reflective surface 43, the second reflective surface 44, and the light exit surface 45 may include free-form surfaces and may be generated by the same continuous function, such that a common mold or mask material may be adopted, thereby effectively reducing manufacturing costs of the optical element 40. An outer contour of a projection area of the optical element 40 onto the micro-display assembly 30 may substantially include a circular shape or an elliptical shape. It may be understood that, in some embodiments, the light incident surface 42 and the first reflective surface 43 may each substantially have an elliptical shape. In some embodiments, the light exit surface 45 may substantially have an elliptical shape. In the elliptical shape, a long axis may correspond to a horizontal field of view of the human eye, and a short axis may correspond to a vertical field of view of the human eye. Considering that the horizontal field of view of the human eye is greater than the vertical field of view, the elliptical outer contour design may be suitable for viewing requirements of the human eye.

Other designs or configurations of the optical element 40 may further refer to related embodiments described in Chinese application numbers CN202311191224.0, CN202420542101.0,CN202311580966.2, or CN202311582204.6.

In some embodiments, as shown in FIG. 4 and FIG. 7, the near-to-eye display module 100a may further include a barrel 46a. The first housing 20 is further provided with a flange 23. The optical element 40 may be disposed in the barrel 46a. The barrel 46a may be movably connected to the flange 23 and may be configured to adjust a distance between the optical element 40 and the micro-display assembly 30. It may be understood that, an internal thread 462 may be provided in the barrel 46a and an external thread may be provided on the flange 23. The barrel 46a and the flange 23 may be threadedly engaged with each other, enabling an adjustment of the distance between the optical element 40 and the micro display 31. In some other embodiments, the barrel 46a may be configured to be releasably connected to the flange 23. The releasable connection may include one or more of various mechanisms for fixing components to each other. For example, the releasable connection may include mechanisms such as locks, latches, snaps, sliders, channels, screws, clasps, threads, magnets, pins, interference (for example, friction) fits, swaging, detents, fusing materials, fabrics, knits, weaves, hook-and-loop fasteners, and/or combinations thereof, to couple the barrel 46a to the first housing 20 and/or to fix them together. The barrel 46a and the first housing 20 may remain fixed to each other until a selected release mechanism is actuated, such as through active operations including squeezing, pressing, rotating, sleeving, snap-fitting, clasping, or etc. by the user. In some embodiments, the first housing 20 and the barrel 46a may be in a closed connection state as shown in FIG. 1 and FIG. 3. Different positions of the optical element 40 relative to the micro display 31 may present digital content with different clarity. For users with different eyesight conditions, a distance of the optical element 40 relative to the micro display 31 may be adjusted according to individual visual requirements.

In some embodiments, as shown in FIG. 7, a second optical element 60a may be further disposed on the barrel 46a. The second optical element 60a may be fixed to the barrel 46a through snap-fitting, bonding, threaded connection, or the like. The second optical element 60a may be disposed on the light-emitting side of the optical element 40. The second optical element 60a may be configured to provide an expected vision correction. The correction of the second optical element 60a may substantially be spherical, aspherical, hyper-aspherical, cylindrical, single-vision, multifocal, progressive, and/or adjustable. The correction of the second optical element 60a may, for example, be applied to specific eye or vision defect populations such as myopia, hyperopia, color blindness, or the like. Various correction combinations of the second optical element 60a may be provided by different lenses or lens pieces. For example, each given lens or lens piece may have known correction parameter types based on an identifier of the design. Corresponding identifiers based on product inventory may be assigned for reference and to facilitate selection for users with different vision requirements. In some embodiments, the second optical element 60a may include a concave lens, a convex lens, or a convex cylindrical lens that has different diopters. The second optical element 60a may perform vision correction on light projected from the optical element 40, such that users with vision defects may clearly view image content from the micro-display 30. In some other embodiments, the first housing 20 and the barrel 46a may be separately detachable. The second optical element 60a may remain fixed to the barrel 46a, such that the barrels 46a including second optical elements with different vision corrections may be replaced according to users with different vision conditions.

In some embodiments, the second optical element 60a may be configured to provide expected optical effects or optical crosstalk. For example, the second optical element 60a may include one or more attenuators, diffusers, filters, polarizers, prisms, beam splitters, diffraction gratings, reflectors, and/or windows. In some embodiments, for users without vision defects, correction may not be required. In this case, the second optical element 60a may adopt a plano lens or a zero-diopter lens without refractive power, which merely provides a protective function for the optical element 40 and reduces wear of the optical element 40.

A projected area of the second optical element 60a in a first direction is greater than or equal to a projected area of the first optical element 40 in the first direction, ensuring that the light from the micro-display 30 may be fully corrected. The barrel 46a may be configured to be releasably connected to the first housing 20, allowing different users to replace different second optical elements 60a according to their own vision requirements, such that users with vision defects can still fully and clearly view digital content from the micro-display 30.

In some embodiments, the projected area of the second optical element 60a in a first direction may be in a range of 15 mm²-45 mm², for example, 15 mm², 17 mm², 19 mm², 20 mm², 36 mm², 40 mm², 45 mm², or the like. The projected area of the first optical element 40 in the first direction may be in a range of 10 mm²-20 mm², for example, 10 mm², 12 mm², 14 mm², 17 mm², 19 mm², 20 mm², or the like. It should be understood that the projected area of the second optical element is required to always be greater than or equal to the projected area of the first optical element 40.

In some embodiments, a projected area of the first housing 20 in the first direction and a projected area of the barrel 46a in the first direction may each be not greater than 60 mm². It should be understood that, for example, the projected area of the first housing 20 and the projected area of the barrel 46a may each be 50 mm², 54 mm², 55 mm², 60 mm², or the like. In some embodiments, for example, as shown in FIGS. 1-3, the projected area of the barrel 46a in the first direction may be greater than the projected area of the first housing 20 in the first direction. In some other embodiments, for example, as shown in FIGS. 6-9, the projected area of the barrel 46a in the first direction may be greater than the projected area of the first optical element 40 in the first direction and may be smaller than the projected area of the first housing 20 in the first direction. Due to the relatively small projected areas of the first housing 20 and the barrel 46a, the first housing 20 and the barrel 46a may have small volumes and weights, facilitating integration with the near-to-eye display apparatus 200a. Compared with existing near-to-eye devices such as an augmented reality (AR) device or a virtual reality (VR) device, the module and the device in some embodiments of the present disclosure may overall have a smaller volume and a lighter weight, which facilitates long-term wearing by the users. In addition, the module and the device may be seamlessly integrated with existing myopia glasses, hyperopia glasses, sunglasses, protective glasses, or smart glasses, without causing excessive weight or size, without appearing overly conspicuous in appearance, and without affecting the user's normal field of view.

The first housing 20, the barrel 46a, the first optical element 40, and the second optical element 60a may substantially have circular, elliptical, or other various shapes. In some embodiments, a material of the first housing 20 and a material of the barrel 46a may be at least partially different. For example, a hardness (rigidity) of the first housing 20 may be greater than a hardness (rigidity) of the barrel 46a. The first housing 20 may be made of metal, plastic, or the like. The barrel 46a may be made of an elastic material or a flexible material, such as silicone, rubber, or elastic plastic. The first housing 20 and the barrel 46a may be elastically connected to each other. In some other embodiments, a hardness of a part of the first housing 20 may be greater than a hardness of a part of the barrel 46a, and such parts may be structures where the first housing 20 and the barrel 46a contact each other. The first housing 20 and the barrel 46a may be elastically sleeved together. In some other embodiments, the first housing 20 and the barrel 46a may be elastically snapped together. That is, the barrel 46a may be snapped to the first housing 20, resulting in at least partial deformation or elastic deformation of the first housing 20 or of the barrel 46a. In some embodiments, in a case where the first housing 20 and the barrel 46a are connected through a threaded connection, the first housing 20 or the barrel 46a may at least partially undergo deformation or elastic deformation. In some other embodiments, for example, an elastic ring (or silicone ring, etc.) may be disposed in a gap of the snap-fitting or threaded connection, or an end of the barrel 46a may abut against a flexible plate (or an elastic plate or a silicone plate). Accordingly, different users may use the second optical elements 60a with different lenses or lens pieces as required, and/or may choose not to use the second optical element 60a including lenses or lens pieces.

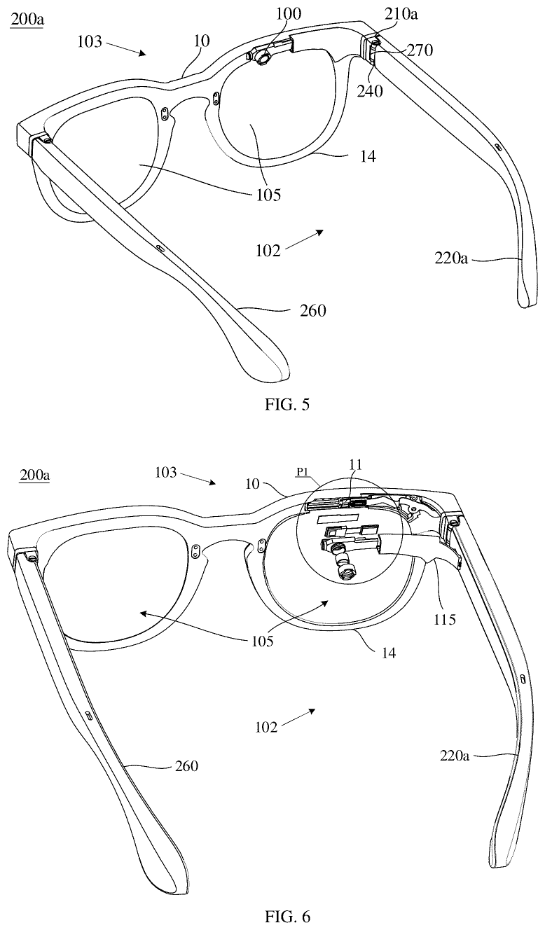

In some embodiments, as shown in FIGS. 5-17, some embodiments of the present disclosure may further provide the near-to-eye display apparatus 200a. The near-to-eye display apparatus 200a may include the frame 10, the first temple 220a, a second temple 260, and the near-to-eye display module 100a as described in the above embodiments. The near-to-eye display module 100a may be disposed on the frame 10. The first temple 220a and the second temple 260 may each be rotatably connected to the frame 10. The first electrical device 230 and a second electrical device 232 may be disposed in the first temple 220a and the second temple 260, respectively. The near-to-eye display module 100a may be electrically connected to the first electrical device 230 and the second electrical device 232. The near-to-eye display apparatus 200a in some embodiments of the present disclosure may be a smart device such as smart glasses, an AR device, a VR device, a mixed reality (MR) device, or the like. The first cavity 101 may be defined in the frame 10. As shown in FIG. 7, the near-to-eye display apparatus 200a may further include a fixing block 16. The fixing block 16 may be fixed in the first cavity 101. The second sliding portion 12 may be disposed on the fixing block 16. It should be understood that the second sliding portion 12 may be formed through directly forming a groove in the frame 10, or through additionally providing the fixing block 16 and forming the second sliding portion 12 on the fixing block 16. Both configurations may be understood as the second sliding portion 12 being defined on the frame 10. The near-to-eye display apparatus 200a may further include a lens 105 disposed on the frame 10. The first housing 20 may be further provided with a scale marking on a side 102 facing the human eye. In a case where the user operates the near-to-eye display module 100a to move relative to the frame 10, the user may clearly observe the movement, thereby accurately meeting the user's adjustment requirements.

As shown in FIG. 1 and FIG. 7, the frame 10 may further include an upper frame 13 and a lower frame 14. The lens 105 may be disposed between the upper frame 13 and the lower frame 14. The upper frame 13 may be located away from the lens 105, i.e., the upper frame 13 may be spaced apart from the lens 105. A rotation range of the first housing 20 toward the lens 105 may be greater than a rotation range of the first housing 20 toward the upper frame 13. It should be understood that the first housing 20 may be allowed to rotate by a larger angle toward the lens 105 or the lower frame 14 than toward the upper frame 13. As shown in FIG. 8, for example, in a case where the near-to-eye display module 100a is assembled to the frame 10, taking S1 as a reference, a rotation angle of the near-to-eye display module 100a in a direction toward a side of the S2 (right side) may be greater than a rotation angle of the near-to-eye display module 100a in a direction away from the side of S2 (left side), thereby facilitating efficient adjustment by the user to a suitable vertical viewing angle.

As shown in FIGS. 5-17, the near-to-eye display module 100a may be at least partially accommodated in the first cavity 101, with a part of the near-to-eye display module 100a being exposed at the first cavity 101. The near-to-eye display module 100a may be configured to move relative to the frame 10, such as sliding or rotating. In some other embodiments, the near-to-eye display module 100a may be fixed to the frame 10. The frame 10 may include a near-to-eye side (human eye side) 102 and a world side (environment side) 103 opposite to the near-to-eye side 102. The near-to-eye display module 100a may be configured to generate light projected toward the near-to-eye side 102 and to project digital content to the eyes of the user on the near-to-eye side 102. In some embodiments, the near-to-eye display module 100a may be configured to project digital content into the human eye through binocular parallax, integral imaging, holographic technology, retinal imaging technology, or the like.

In some embodiments, the lens 105 may be detachably connected to the frame 10, thereby allowing the user to replace lenses with different vision corrections. In some embodiments, the lens 105 may be fixedly connected to the frame 10 and not detachable by the user. The number of the near-to-eye display module 100a may be one, two or more. In some embodiments, the lens 105 may be a plano lens, a sunglass lens, or a protective lens. In some other embodiments, the lens 105 may be a vision-correcting lens, for example, a correcting lens for specific eye or vision defect populations with myopia, hyperopia, color blindness, or the like. The lens 105 may substantially be spherical, aspherical, hyper-aspherical, cylindrical, single-vision, multifocal, progressive, and/or adjustable. In some embodiments, in a direction from the near-to-eye side 102 to the world side 103, a projected area of the near-to-eye display module 100a may not overlap with the lens 105, thereby reducing interference of the near-to-eye display module 100a with a normal field of view of the lens 105. In some other embodiments, in the direction from the near-to-eye side 102 to the world side 103, the projected area of the near-to-eye display module 100a may partially overlap with the lens 105. In some embodiments, the near-to-eye display module 100a may further be configured to move into an area of the lens 105, that is, allowing the near-to-eye display module 100a to be adjusted at a predetermined or arbitrary position of the lens 105.

A first limiting portion 210a may be connected to the frame 10. The first limiting portion 210a may be connected to the frame 10 through bonding, snap-fitting, hinge connection, fastener fixation, or the like. A material of the first limiting portion 210a and a material of the frame 10 may be the same or different. A first through hole 201 may be defined on the first limiting portion 210a. The first through hole 201 may be in communication with the first cavity 101. A second cavity 221 may be defined by the first temple 220a. The first electrical device 230 may be disposed in the second cavity 221. The first electrical device 230 may include a circuit board. As shown in a system block view, i.e., FIG. 17, the circuit board may be rigid or flexible, and may be a single board or may include multiple boards electrically connected to each other. The circuit board may include, for example, the processor 2301, a memory 2302, a peripheral component 2308 such as an external capacitor, a resistor, an inductor, etc., and an operating unit 2307, such as a switch or a control button. In some embodiments, an electrical device, such as a microphone 2304 or a sensor 2306, e.g., a biometric sensor, an environmental light sensor, or a brightness sensor, may further be disposed in the second cavity 221.

A second limiting portion 240 may be connected to the first temple 220a. The second limiting portion 240 may be connected to the first temple 220a through bonding, snap-fitting, hinge connection, fastener fixation, or the like. A second through hole 241 may be defined in the second limiting portion 240. The second through hole 241 may be understood as a slot, a recess, a through slot, or a mounting slot, or the like, that allows placement of a component or passage of a component therethrough. The second limiting portion 240 may be rotatably connected to the first limiting portion 210a. A hinge connection, a rotary joint, a spring hinge, or the like may be adopted between the second limiting portion 240 and the first limiting portion 210a. That is, the first temple 220a may be rotatably connected to the frame 10 through the second limiting portion 240 and the first limiting portion 210a. The second through hole 241 may be in communication with the second cavity 221. The first through hole 201 may be in communication with the first cavity 101. The first conductive line 250 may pass through the first through hole 201 and the second through hole 241 and may be electrically connected the near-to-eye display module 100a and the first electrical device 230.

A third cavity 261 may be defined in the second temple 260. The second temple 260 may be rotatably connected to the frame 10. The first temple 220a may be rotatably connected to the frame 10. In some other embodiments, the first temple 220a may be fixedly connected to the frame 10. The second electrical device 232 may be disposed in the third cavity 261. The second electrical device 232 may be a power module, for example, a rechargeable battery or a replaceable battery through a charging interface 2322. A second conductive line 252 may extend laterally along the frame 10. The lateral extension may be understood as extending across a direction of left and right lenses 105, i.e., across a direction of the left and right eyes of the user after the near-to-eye display apparatus 200a is worn. The second conductive line 252 may pass through the first through hole 201 and the second through hole 241 and may be electrically connected to the second electrical device 232 and the first electrical device 230. The first conductive line 250 and the second conductive line 252 may be flexible electrical lines, which may be bent, curved, or folded. In some other embodiments, the first conductive line 250 may be a flexible wire, and the second conductive line 252 may be a non-flexible wire. Electrically conductive traces may be printed on the first conductive line 250 and the second conductive line 252. The first conductive line 250 and the second conductive line 252 may be elongated and flat. In some other embodiments, the first conductive line 250 and the second conductive line 252 may be cylindrically elongated, or may be formed by a plurality of thin cylindrically elongated wires arranged in parallel. Overlapping projected portions of the first conductive line 250 and the second conductive line 252 on the frame 10 may be electrically insulated from each other. Metal conductive traces (for example, copper, etc.) may be printed inside the first conductive line 250 and the second conductive line 252. A surface of the first conductive line 250 and a surface of the second conductive line 252 may be coated with an insulating material, such that contact between the first conductive line 250 and the second conductive line 252 may not cause an electrical short circuit. The frame 10 and a temple housing may be made of a plastic material. The first limiting portion 210a and the second limiting portion 240 may be made of a metal material.

In the related art, a connection structure between the frame and the temple may often be involved. During rotation of the temple relative to the frame, an internal electrical line may be often exposed at the connection structure. During long-term user operations such as rotation for wearing and removal, the internal electrical line may be prone to damage. By disposing the near-to-eye display module 100a on the frame 10, disposing the first electrical device 230 in the first temple 220a, and disposing the second electrical device 232 in the second temple 260, an overall weight of the near-to-eye display apparatus 200a may be effectively balanced without the need of an additional counterweight component. Besides, the first conductive line 250 may be electrically connected the near-to-eye display module 100a and the first electrical device 230. The second conductive line 252 may extend laterally and may be electrically connected to the near-to-eye display module 100a and the second electrical device 232. Both the first conductive line 250 and the second conductive line 252 may pass through the first through hole 201 and the second through hole 241, thereby effectively reducing exposure of the first conductive line 250 and the second conductive line 252, and effectively reducing wear of the first conductive line 250 and the second conductive line 252 during use. Through disposing the battery and the like as the second electrical device 232 separately in the second temple 260, and electrically connecting the second electrical device 232 and the first electrical device 230 through the laterally extending second conductive line 252, space of each temple can be fully utilized. For example, the second temple 260 may allow placement of a large-capacity battery and may be electrically connected to the near-to-eye display module 100a through the extended second conductive line 252, thereby effectively improving an endurance of the apparatus.

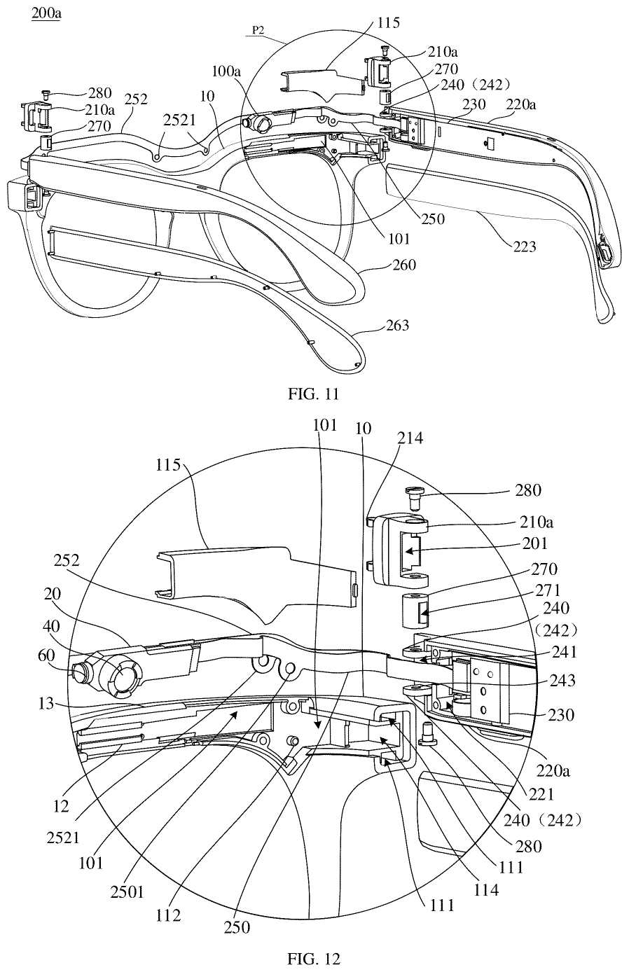

In some embodiments, as shown in FIGS. 11-14, a length of the first conductive line 250 may be smaller than a length of the second conductive line 252. The near-to-eye display module 100a may be configured to be movable on the frame 10. The user may touch the near-to-eye display module 100a with a finger or a tool to realize movement. In a case where the near-to-eye display module 100a moves relative to the frame 10, the first conductive line 250 may at least partially move within the first cavity 101. Movement of the first conductive line 250 may be understood as the first conductive line 250 being bent, folded, stretched, or expanded. In some embodiments, the near-to-eye display module 100a may be configured to move in a direction toward the first temple 220a and to bend the first conductive line 250. The near-to-eye display module 100a may be further configured to move in a direction away from the first temple 220a and to expand the first conductive line 250. In a case where the user slides the near-to-eye display module 100a in the direction toward the first temple 220a, the first conductive line 250 may be bent or folded, resulting in the first conductive line 250 to be retracted or coiled and located in the first cavity 101. In a case where the user slides the near-to-eye display module 100a in the direction away from the first temple 220a and toward the second temple 260, the first conductive line 250 may be stretched, expanded, or may tend to be stretched and located in the first cavity 101. The second conductive line 252 may be located in the frame 10 and may remain fixed. The second conductive line 252 may be fixed in the frame 10 through potting, bonding, snap-fitting, or fastener connection. During movement of the near-to-eye display module 100a, only a part of the first conductive line 250 may be coiled or stretched, and the second conductive line 252 may not be affected, thereby effectively ensuring stability of respective electrical connections. A part of the first conductive line 250 and a part of the second conductive line 252 that overlap with each other, in an extension direction of the first conductive line 250 and the second conductive line 252, may be electrically insulated. It should be understood that at positions of the first cavity 101, the first through hole 201, and the second through hole 241, in a projection direction from the near-to-eye side 102 to the environment side 103, the first conductive line 250 may at least partially overlap with the second conductive line 252. For example, the first conductive line 250 and the second conductive line 252 may each adopt a flat flexible circuit board. The first conductive line 250 and the second conductive line 252 may be made of polyester, polyethylene naphthalate, polyimide, liquid crystal polymer, or the like. In some embodiments, metal conductive layers may be printed inside the first conductive line 250 and the second conductive line 252. The surface of the first conductive line 250 and the surface of the second conductive line 252 may respectively be coated with the insulating material, such that the surface of the first conductive line 250 and the surface of the second conductive line 252 are electrically insulated from each other. A direct contact between the surface of the first conductive line 250 and the surface of the second conductive line 252 may not conduct electricity, which facilitates in ensuring independence of respective electrical circuits and reduces a risk of short circuits.

In some embodiments, as shown in FIGS. 11-17, a first snap hole 2501 may be defined on the first conductive line 250, and a second snap hole 2521 may be defined on the second conductive line 252. Sizes and shapes of the first snap hole 2501 and the second snap hole 2521 may be the same. Electrically conductive layers on the first conductive line 250 and the second conductive line 252 may respectively avoid the first snap hole 2501 and the second snap hole 2521. Since the second conductive line 252 extends laterally along the frame 10, the number of the second snap hole 2521 may be at least two and the at least two second snap holes 2521 may be spaced apart from each other. For example, the number of the second snap holes 2521 along the lateral direction of the frame 10 may be two or three. At least two snap posts 112 may be disposed on the frame 10. The first snap hole 2501 and the second snap hole 2521 may be respectively connected to the snap posts 112. For ease of understanding, only the snap post 112 located in the first cavity 101 is shown in the figures. In practice, similar snap posts 112 may further be disposed along the lateral direction of the frame 10 (not shown). For example, the second snap hole 2521 may be located at a middle position of the frame 10 or near a position corresponding to a bridge of the user's nose after wearing. Positions of the snap posts 112 may correspond to the second snap holes 2521. It should be understood that the snap posts 112 may be formed by adhesive passing through the snap holes 2521 and being cured during a potting process. In some embodiments, the snap posts 112 may be shared. In a case where the number of the second snap hole 2521 is two, one second snap hole 2521 may be defined on the middle position of the frame 10 and the other second snap hole 2521 may be defined on a position corresponding to the first snap hole 2501. In other words, along the first direction, an orthographic projection of the first snap hole 2501 and an orthographic projection of the other second snap hole 2521 may substantially overlap with each other. In this case, the number of the snap post 112 may be two. That is, one snap post 112 may be connected to the second snap hole 2521 defined on the middle position of the frame 10, and the other snap post 112 may be connected to both the first snap hole 2501 and the other second snap hole 2521 defined corresponding to the first snap hole 2501. For example, the snap posts 112 may be further connected to a sealing plate 115. By respectively fixing the first snap hole 2501 and the second snap hole 2521 to the snap posts 112, the first conductive line 250 and the second conductive line 252 may be fixed, which facilitates efficient assembly of the near-to-eye display apparatus 200a. In addition, in a case where the near-to-eye display module 100a moves relative to the frame 10, the first conductive line 250 may be fixed by the snap posts 112 located between the first temple 220a and the near-to-eye display module 100a. In this way, the first conductive line 250 may be allowed to move between the first sliding portion 50 and the snap posts 112, thereby effectively reducing excessive movement of the first conductive line 250 and reducing a risk of damage to the first conductive line 250.

In the related art, a rotation structure of the temple relative to the frame may often form a large opening at a hinge position. Especially in a case where the temple is changed from an unfolded state to a folded state and so on, the larger a range of the rotation from a large angle to a small angle, the wider the opening at the hinge structure position. In this way, the conductive lines may be easily exposed during rotation. On the other hand, a pivot of such hinge structure may not rotate itself. In this case, during the rotation, the conductive lines may be forced to bend at the opening. During long-term use, damage to the conductive lines may be likely to occur. In some embodiments, as shown in FIGS. 11-16, the near-to-eye display apparatus 200a may further include a rotating shaft 270. The rotating shaft 270 may be rotatably connected to the second limiting portion 240 and/or the first limiting portion 210a. That is, the rotating shaft 270 may be allowed or enabled to rotate relative to the second limiting portion 240, may be allowed or enabled to rotate relative to the first limiting portion 210a, or may be allowed or enabled to rotate simultaneously relative to the first limiting portion 210a and the second limiting portion 240. A third through hole 271 may be defined on the rotating shaft 270. The first through hole 201, the second through hole 241, and the third through hole 271 in some embodiments of the present disclosure may each be understood as a slot, a through slot, or a recess structure, and may be further understood as a structure in which a component may be disposed or through which the component may pass. The first cavity 101, the first through hole 201, the third through hole 271, and the second cavity 221 may be in communication with each other. The first conductive line 250 and the second conductive line 252 may pass through the third through hole 271. The rotating shaft 270 may be configured to drive the first conductive line 250 and the second conductive line 252 to rotate synchronously. The rotating shaft 270 may be disposed at the second limiting portion 240 and located in the second through hole 241. The rotation of the rotating shaft 270 may be configured to drive the first conductive line 250 and the second conductive line 252 to rotate together integrally. That is, the first conductive line 250 and the second conductive line 252 may follow the rotation of the rotating shaft 270 and rotate synchronously. For example, in a case where the first temple 220a rotates relative to the frame 10, the rotating shaft 270 may be driven by the first temple 220a to rotate correspondingly, thereby allowing the first conductive line 250 and the second conductive line 252 themselves to rotate synchronously, rather than merely bending the first conductive line 250 and the second conductive line 252. During the rotation of the first temple 220a relative to the frame 10, the third through hole 271 may remain in communication with the first temple 220a, without being easily exposed and clearly observed by the user, thereby effectively reducing the exposure of the first conductive line 250 and the second conductive line 252 during rotation, and reducing a risk of damage to the conductive lines caused by ingress of water or other foreign objects. Under the same or larger rotation angles (compared to the related art), some embodiments of the present disclosure may reduce an opening size of the third through hole 271 during rotation of the temple relative to the frame, save materials, and reduce wear caused by bending or folding of the first conductive line 250 and the second conductive line 252, thereby effectively improving protection of the first conductive line 250 and the second conductive line 252 during rotation.

In some embodiments, as shown in FIGS. 11-14, the near-to-eye display apparatus 200a may further include a fastener 280. The fastener 280 may be a screw, a bolt, or the like. The first limiting portion 210a may include a first connecting segment 212. A fourth through hole 213 may be defined on the first connecting segment 212. The second limiting portion 240 may include a second connecting segment 242. A fifth through hole 243 may be defined on the second connecting segment 242. A fixing hole 272 may be defined on the rotating shaft 270. The fixing hole 272, the fourth through hole 213, and the fifth through hole 243 may be coaxially arranged. The first connecting segment 212 and the second connecting segment 242 may each be an arc-shaped protrusion or an annular protrusion. The fastener 280 may pass through the fourth through hole 213 and the fifth through hole 243 and may be connected to the fixing hole 272. For example, a single fastener 280 may pass completely through the fourth through hole 213 and the fifth through hole 243 and be connected to the fixing hole 272. In some embodiments, the second connecting segment 242 may be located on an inner side of the first connecting segment 212, and the rotating shaft 270 may be located on an inner side of the second connecting segment 242. In some other embodiments, the second connecting segment 242 may be located on an outer side of the first connecting segment 212, and the rotating shaft 270 may be located on an inner side of the first connecting segment 212.

In some embodiments, as further shown in FIG. 15, the number of the first connecting segment 212 may be two and the two first connecting segments 212 may be disposed opposite to each other. The number of the second connecting segment 242 may be two and the two second connecting segments 242 may be disposed opposite to each other. The number of the fastener 280 may be two and the two fasteners 280 may be disposed opposite to each other. The second connecting segments 242 may be located between the two first connecting segments 212. The first connecting segments 212 and the second connecting segments 242 may substantially be U-shaped or semi-I-shaped, respectively. In some embodiments, the two first connecting segments 212 may be substantially disposed in parallel. The rotating shaft 270 may be disposed between the two second connecting segments 242. Each of the two fasteners 280 may be connected to a corresponding one of the two second connecting segments 242 and a corresponding one of the two first connecting segments 212. The first conductive line 250 and the second conductive line 252 may be located between the two fasteners 280. The fasteners 280 may penetrate the third through hole 271 without completely passing through the third through hole 271. That is, an end of each fastener 271 may be inserted and located in the third through hole 271. In some embodiments, the number of the fastener 280 may be one, and the fastener 280 may completely pass through the third through hole 271. The first conductive line 250 and the second conductive line 252 may each be spaced apart from the fasteners 280. Through providing two fasteners 280 to respectively fix the first connecting segments 212 and the second connecting segments 242, contact between each of the first conductive line 250 and the second conductive line 252 with the fasteners 280 may be effectively reduced, thereby reducing wear on the conductive lines.

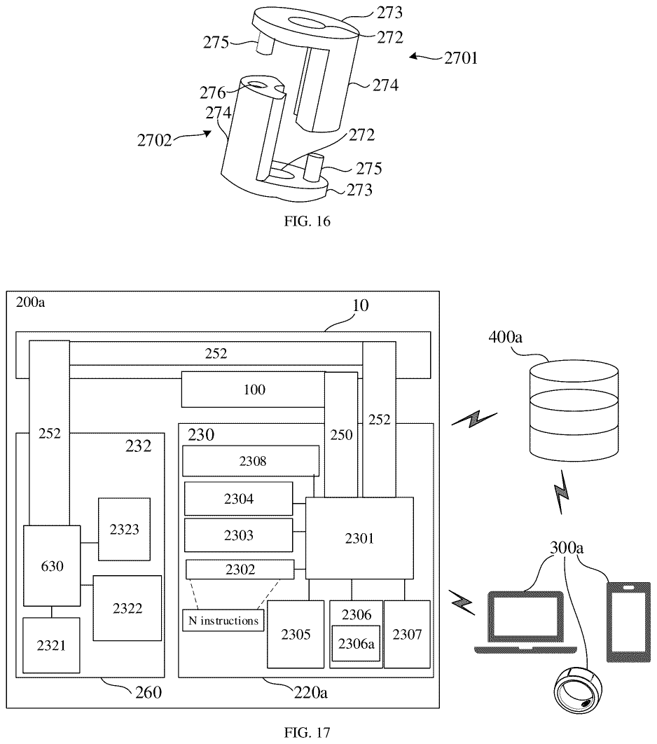

In some embodiments, as shown in FIG. 16, the rotating shaft 270 may include a first shaft segment 2701 and a second shaft segment 2702. A structure of the first shaft segment 2701 and a structure of the second shaft segment 2702 may be substantially the same. Each of the first shaft segment 2701 and the second shaft segment 2702 may include an annular segment 273, an extension segment 274, and a fixing segment 275. The fixing hole 272 may be defined in the annular segment 273. The extension segment 274 and the fixing segment 275 may respectively extend in directions away from the annular segment 273. The extension segment 274 and the fixing segment 275 may be spaced apart from each other around a circumference of the fixing hole 272. A connection hole 276 may be defined in the extension segment 274. A size of the extension segment 274 may be greater than a size of the fixing segment 275. The fixing segment 275 may have a substantially columnar protruding structure. The fixing segment 275 of the first shaft segment 2701 may be connected to the connection hole 276 of the extension segment 274 of the second shaft segment 2702. The connection hole 276 of the extension segment 274 of the first shaft segment 2701 may be connected to the fixing segment 275 of the second shaft segment 2702. The fixing segment 275 and the connection hole 276 may be connected through snap-fitting, insertion, adhesive bonding, or the like. It can be understood that the first shaft segment 2701 and the second shaft segment 2702 may be each assembled from a same structure and may be directly formed using a same set of molds, thereby effectively reducing mold development costs. The first shaft segment 2701 and the second shaft segment 2702 may be made of plastic or the like. A material of the rotating shaft 270 may be different from the material of the first limiting portion 210a and a material of the second limiting portion 240, thereby effectively reducing material and processing costs. Apparently, in some other embodiments, the rotating shaft 270, the first limiting portion 210a, and the second limiting portion 240 may be made of the same material, thereby improving overall structural strength.

In some embodiments, as shown in FIGS. 11-15, two oppositely arranged connection slots 111 may be defined on the frame 10. The first limiting portion 210a may further include a first limiting main body 214 and a first protruding part 215. The first protruding part 215 and the first connecting segment 212 may be respectively located at two ends of the first limiting main body 214. The first protruding part 215 may extend toward a side away from the first connecting segment 212. The number of the first protruding part 215 may be two. The two first protruding parts 215 may be spaced apart from each other. The two first protruding parts 215 may be respectively connected to the two connection slots 111 through a fixed connection. The fixed connection may, for example, include snap-fitting, interference fitting, adhesive bonding, or the like. In some embodiments, a corresponding guide groove (not shown in the figures) may be defined on an inner wall of each connection slot 111, which facilitates the first protruding parts 215 to be accurately snapped into the connection slots 111. The two first protruding parts 215 may be substantially parallel to each other. The two first connecting segments 212 may be substantially parallel to each other. The first protruding parts 215 may be substantially parallel to the first connecting segments 212. The first through hole 201 may penetrate through the first limiting main body 214. The first protruding parts 215 and the first connecting segments 212 may be located on two sides of the first through hole 201. The frame 10 may further define a transition groove 114. The transition groove 114 may be in communication with the first cavity 101. The first conductive line 250 and the second conductive line 252 may extend from the first cavity 101 through the transition groove 114, then enter the third through hole 271, and finally enter the second cavity 221 to be electrically connected to the first electrical device 230 therein. One of the two connection slots 111 may be located above the transition groove 114, and the other one of the two connection slots 111 may be located below the transition groove 114. Through the above arrangement, the frame 10 and the first limiting portion 210a may be made of different materials, and the first protruding parts 215 may be stably connected to the connection slots 111, which facilitates a concealed installation of the first conductive line 250 and the second conductive line 252 without exposure.

In some embodiments, as shown in FIGS. 11-15, the first protruding part 215 may include periodically arranged protrusions extending away from the first limiting main body 214. The protrusions may be, for example, wave-shaped undulations, sinusoidal recessed protrusions, or multiple spaced protrusions. Such periodically arranged protrusions 215 may facilitate forming a large contact area, providing sufficient adhesive bonding between the first protruding part 215 and the connection slot 111, and guiding the first protruding part 215 to be snapped into the connection slot 111. In some embodiments, at least one through hole 216 may be defined on the first protruding part 215. The through hole 216 may be configured to accommodate adhesive, which facilitates accommodating a great amount of adhesive. In this way, the first protruding part 215 may be more firmly and stably connected to the connection slot 111, thereby improving the stability of the connection between the first protruding part 215 and the connection slot 111. In addition, the through hole 216 may effectively reduce the overall weight of the first limiting portion 210a, thereby further reducing the weight of the near-to-eye display apparatus 200a. The through hole 216 may further facilitate an elastic deformation of the first protruding part 215, thereby enabling the first protruding part 215 to be easily snapped into the connection slot 111.

As shown in FIGS. 4-7, the micro-display assembly 30 may include the micro display 31, the third conductive line 32, and the first electrical interface 33 that are electrically connected to each other. The micro display 31 may be aligned with the optical element 40. The third conductive line 32 may be connected between the micro display 31 and the first electrical interface 33. The second electrical interface 2510 may be defined on the first conductive line 250. The second electrical interface 2510 may be electrically plugged and connected to the first electrical interface 33. The near-to-eye display apparatus 200a may further include the sealing plate 115. The sealing plate 115 may be connected to the frame 10 and may be configured to seal the first cavity 101. A positioning post 113 may be disposed on the frame 10. The sealing plate 115 may be fixedly connected to the positioning post 113 first, and then sealed to the frame 10 using sealing adhesive or the like, thereby effectively reducing the exposure of the first conductive line 250.

As shown in FIGS. 11-16, a rotation connection structure between the second temple 260 and the frame 10 may be substantially the same as the rotation connection structure between the first temple 220a and the frame 10. That is, the various embodiments described above with respect to the first limiting portion 210a, the second limiting portion 240, and the rotating shaft 270 may likewise be applicable to the rotation connection between the second temple 260 and the frame 10, and details thereof will not be repeated herein.

It can be understood that the first electrical device 230 may include a main control circuit board, on which the processor 2301, the memory 2302, a transceiver 2303, and the peripheral component 2308, such as the capacitor, the resistor, the inductor, etc. The microphone 2304, a right speaker 2305, an inertial sensor 2306a, and the operation unit 2307 configured to implement an interaction by switches, touch, or physical operations may further be disposed in the first temple 220a. The above components may be electrically connected to the first electrical device 230, where all or part of them may be disposed on the main control circuit board of the first electrical device 230, or may be disposed separately from the main control circuit board. The second electrical device 232 may include the rechargeable battery. The second temple 260 may further include a left speaker 2321, the charging interface 2322, a brightness or vital-sign sensor 2323, etc., thereby effectively balancing the weights of the left temple and the right temple without the need of additionally providing a counterweight component, and ensuring a light overall weight of the near-to-eye display apparatus 200a. The microphone 2304 may be configured to collect a sound source from the environment or the wearer. The number of the microphone 2304 may be one or more. The charging interface 2322 may support wired charging or wireless charging. The left speaker 2321 and the right speaker 2305 may be configured to play audio. The brightness sensor 2306 may be configured to detect an ambient light condition and to adaptively adjust a display brightness of the micro-display 1101. The inertial sensor 2306a may be configured to detect a posture of the wearer. The operation unit 2307 may be configured to enable the wearer to directly perform an operation to achieve interaction, such as power on/off, page turning, volume adjustment, play/pause, quick wake-up, quick invocation of a local artificial intelligence assistant, or the like.

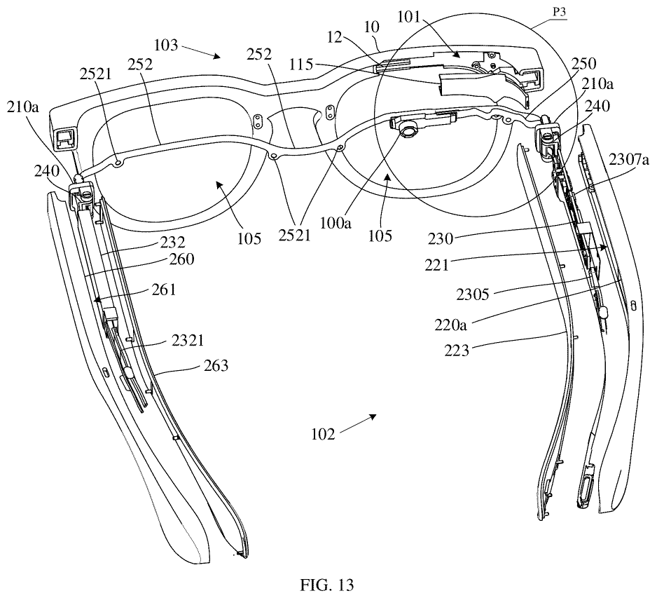

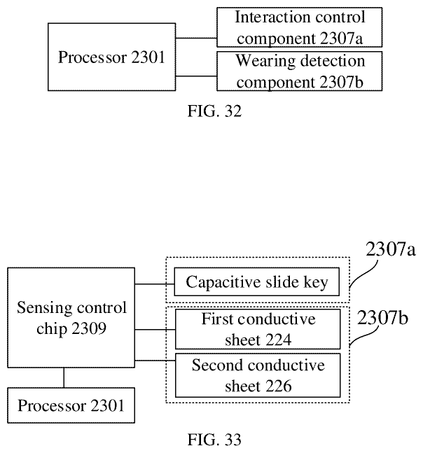

In some embodiments, as shown in FIGS. 13, 17, and 31-33, the operation unit 2307 may further include an interaction control component 2307a. The interaction control component 2307a may be configured to receive an interactive operation signal input by the user and to convert the interactive operation signal into a first electrical signal. The interaction control component 2307a may be electrically connected to the circuit board. The interaction control component 2307a may be disposed on a side of the first temple 220a away from the human eye side 102. The interaction control component 2307a may be disposed at a location close to the frame side and a surface of the location may have micro-recesses or a matte texture, so as to assist the user in accurately locating an operation area (for example, a sliding area) without visual observation. The near-eye display apparatus 200a may further include a wearing detection component 2307b. The wearing detection component 2307b may be electrically connected to the circuit board. The wearing detection component 2307b may be disposed on a side of the first temple 220a facing the human-eye side 102. The wearing detection component 2307b may be configured to sense a wearing state of the user and generate a second electrical signal. The processor 2301 may be configured to obtain the second electrical signal from the wearing detection component 2307b on an inner side in real time. In a case where a differential value reaches a preset threshold, the wearing state may be determined to be a “worn” state; otherwise, the wearing state may be determined to be a “not worn” state. It may be understood that the first electrical signal (interaction control) and the second electrical signal (wearing detection) may be directly or indirectly transmitted to the processor 2301 through a signal transmission channel inside the temple (such as a flexible circuit board or bonding wires). The processor 2301 may be configured to monitor the second electrical signal. In a case where the differential value of the second electrical signal exceeds the preset wearing threshold, the processor may be configured to output an internal logical state of “wearing valid”. In case of the “wearing valid” state, the processor 2301 may be configured to start to parse the first electrical signal from the interaction control component 2307a on an outer side. The processor 2301 may be configured to identify a “forward sliding” or a “backward sliding” according to level fluctuation characteristics of the first electrical signal, for example, a movement direction of a charge centroid. The processor 2301 may then be configured to internally convert the signal into a system control instruction, such as a volume control instruction or an application control instruction, etc.

In some embodiments, the interaction control component 2307a may be disposed on an inner wall of an outer side surface of the temple. The wearing detection component 2307b may be disposed on an inner wall of an inner side surface of the temple. Due to limited space in a thickness direction of a main body of the temple, an orthographic projection of the interaction control component 2307a on the inner side surface may spatially overlap at least partially with the wearing detection component 2307b. An insulating isolation layer having a particular dielectric constant (such as a bracket portion of the temple main body or a dedicated shielding sheet) may be disposed between the interaction control component 2307a and the wearing detection component 2307b. A physical spacing distance between the interaction control component 2307a and the wearing detection component 2307b in the thickness direction may be controlled to be between 1.2 mm and 2.5 mm.

In some embodiments, as shown in FIG. 31, the wearing detection component 2307b may include a first conductive sheet 224 and a second conductive sheet 226, which both extend along a length direction of the first temple 220a. The two conductive sheets may be made of a metal material (such as stainless steel or gold-plated copper), may be insulated from each other, and may both be disposed within a range that is accessible to or sensed at a close distance by skin when worn by the user. In some embodiments, the first conductive sheet 224 and the second conductive sheet 226 may be disposed in parallel along the length direction of the temple. In some embodiments, extension lengths of the first conductive sheet 224 and the second conductive sheet 226 may each account for more than one third of a total length of the temple. The first conductive sheet 224 and the second conductive sheet 226 may be formed on an injection-molded surface of an inner side of the temple, and may be manufactured through a laser direct structuring (LDS) process or a metal foil lamination process. The first conductive sheet 224 may be configured to sense skin contact (which may be direct or indirectly sensed through a temple housing). The second conductive sheet 226 may be disposed at a position close to an upper edge or a lower edge of the temple to minimize direct skin contact. The second conductive sheet 226 may be configured to collect an environmental noise level as a reference baseline.

In some embodiments, an exposed area or an effective sensing area of the first conductive sheet 224 may be greater than that of the second conductive sheet 226. The exposed area of the first conductive sheet 224 may be about three to five times that of the second conductive sheet 226. A surface area of the first conductive sheet 224 may be greater than that of the second conductive sheet 226. Such an asymmetric design of a “large detection electrode plus small reference electrode” may fully utilize a differential measurement principle. When the temple is worn by the user, the skin may mainly contact the first conductive sheet 224. A processor chip may effectively reduce common-mode interference caused by sweat, ambient humidity, or temperature drift through comparing signal differences between the first conductive sheet 224 and the second conductive sheet 226. In some embodiments, the first conductive sheet 224, the second conductive sheet 226, and the interaction control component 2307a may all be completely encapsulated inside the housing of the temple main body. Outer surfaces of the inner side surface and the outer side surface of the temple may both be continuous and sealed insulating material surfaces (such as plastic, resin, or ceramic), and may have no metal contact points or sensing holes. The wearing detection component 2307b may be configured to identify the wearing state through sensing changes in a fringe electric field generated when human tissue approaches. The sensing electric field may penetrate the thickness of the temple housing (for example, 0.5 mm to 1.0 mm) to act on user skin. Since the conductive sheets do not directly contact human skin, electrochemical corrosion of metal electrodes caused by sweat and oil during wearing may be reduced, enabling the system to readily achieve an IP67 or higher waterproof rating. The temple surface may not require openings or embedded conductive metal, thereby maintaining consistency of appearance. In a case where the user performs sliding operations on the apparatus or wears the apparatus, the user may contact the housing material with a softer tactile feel, thereby reducing a risk of metal allergy.

In some embodiments, the interaction control component 2307a may include a capacitive sensing electrode disposed on an outer side of the temple. The interaction control component 2307a may be configured to identify clicking, double-clicking, long-pressing, or sliding operations along an axial direction of the temple through detecting capacitance changes generated when the user's finger approaches or contacts the electrode. In some embodiments, the interaction control component 2307a may include a mechanical button, a dial, or a micro-switch. The interaction control component 2307a may be configured to generate an on-off signal through physical displacement. The mechanical button may serve as a hardware reset switch of the system or a high-frequency confirmation operation item. In some embodiments, the interaction control component 2307a may include an induction coil. The interaction control component 2307a may be configured to identify a slight deformation of a metal housing through an inductive sensing principle. The above approach may be suitable for a fully sealed and waterproof temple design. The user may trigger an interaction instruction by pressing a metal outer shell of the temple. In some embodiments, the interaction control component 2307a may include a piezoelectric sensor, a thin-film pressure gauge, or a strain gauge. The interaction control component 2307a may be configured to sense a pressing force applied by the user to the temple. By setting different pressure thresholds, the system may distinguish between a “light touch” and a “hard press”, thereby implementing multi-level function expansion at a same physical position. In some embodiments, the interaction control component 2307a may include an infrared receiver module, an ambient light sensor, or a micro laser ranging module. The interaction control component 2307a may be configured to identify hovering or gesture actions of a finger near the temple through detecting occlusion or changes in reflected light intensity. In some embodiments, the interaction control component 2307a may include a micro-electro-mechanical system (MEMS) inertial measurement unit, such as an accelerometer or a gyroscope, etc. The user may implement interaction control of the glasses by tapping the temple (to generate certain vibration characteristics) or by head shaking at certain frequency.

In some embodiments, as shown in FIG. 33, the near-eye display apparatus 200a may further include a sensing control chip 2309. The sensing control chip 2309 may be electrically connected to the processor 2301, for example, through a standard I2C communication interface. The interaction control component 2307a and the wearing detection component 2307b may both be electrically connected to the sensing control chip 2309. It may be understood that the first conductive sheet 224 and the second conductive sheet 226 on the inner side may be electrically connected to differential sensing pins of the sensing control chip 2309, respectively. The electrical signal generated by the interaction control component 2307a on the outer side may be transmitted to a touch input pin. The sensing control chip 2309 may utilize an internal sensing engine thereof to perform analog-to-digital conversion, noise filtering, and automatic calibration processing on raw signals. The chip may be configured to internally perform gesture algorithm computation on touch signals (such as determining a sliding direction and displacement), and may perform logical determination of the wearing state. It may be understood that the system may provide multiple power consumption modes, including a dynamic mode, a monitoring mode, and a deep sleep mode. In a case where the wearing detection component 2307b detects that the user is not wearing the glasses, the sensing control chip 2309 may be configured to notify the processor 2301 to enable the system to enter an ultra-low power consumption mode. Once a wearing behavior is detected, the system may rapidly switch to the dynamic mode and may monitor sliding events of the interaction control component 2307a on the outer side in real time. The processor 2301 may be configured to read an event register of the sensing control chip 2309 (for example, address 0x11). Only in a case where the wearing state is determined to be “worn”, the processor 2301 may be configured to respond to the sliding control instruction generated by the interaction control component 2307a on the outer side, thereby reducing accidental touch when the user removes the glasses or holds the temple. By simultaneously managing inner-side and outer-side sensing through the sensing control chip 2309, a PCB size may be reduced, which may be suitable for compact space of the glasses temple. The above three-level architecture of “sensing terminal-preprocessing terminal-system main control terminal” may realize “link integration” of signals. The processor 2301 may not be required to directly process complex capacitive raw signals, and may only be configured to receive digital instructions output by the sensing control chip 2309 (such as “wearing successful” or “sliding 10 units”), thereby greatly saving computation resources and I/O occupancy of the main controller and ensuring accuracy of control instructions in complex environments.

In some embodiments, the interaction control component 2307a may further perform preliminary signal acquisition and denoising processing through a dedicated low-power touch chip (not shown in the figure). The interaction control component 2307a may then be configured to transmit data to the sensing control chip 2309. The touch chip may support self-capacitance and mutual-capacitance integrated detection, thereby providing a higher signal-to-noise ratio.

In some embodiments, the memory 2302 may include a high-speed random access memory or a non-volatile memory, such as one or more magnetic storage devices, one or more optical storage devices or flash memory. The memory 2302 may store N instruction sets for processing a basic system service and executing a hardware-related task. The instruction sets may be configured to facilitate processing related to the sensor or the interface. The memory 2302 may further store an operating system, such as Darwin, real-time eXecutive in C (RTXC), LINUX, UNIX, Android, iOS, WINDOWS, or other embedded operating systems. The memory 2302 may store one or more programs configured to be executed by the one or more processors 2301. The one or more programs may include instruction sets for operation.

In some embodiments, the transceiver 2303 may include a wireless communication unit, and may include a radio-frequency receiver and transmitter and/or an optical (for example, infrared) receiver and transmitter. The transceiver 2303 may be designed to operate through a global system using one or a combination of the following: global system for mobile communications (GSM) network, general packet radio service (GPRS) network, enhanced data GSM environment (EDGE) network, IEEE 802.xx communication network (such as WiFi, WiMax, ZigBee™), 3G network, 4G network, 4G LTE network, 5G network, code division multiple access (CDMA) network, near field communication (NFC) network, WiFi Direct network, infrared network, and Bluetooth network. The wireless communication unit may include a hosted protocol, enabling the device to be configured as a base station for another wireless device. In another example, a communication subsystem may allow the device to synchronize with a host device using one or more protocols or communication technologies, such as transmission control protocol/internet protocol (TCP/IP), hypertext transfer protocol (HTTP), user datagram protocol (UDP), internet control message protocol (ICMP), post office protocol (POP), file transfer protocol (FTP), distributed component object model (DCOM), or any other known communication protocols or technologies.

FIG. 17 illustrates an application example of a network environment of the near-to-eye display apparatus 200a. The network environment may include the near-to-eye display apparatus 200a, an external terminal device 300a, and an external or local cloud computing platform or server 400a. The near-to-eye display apparatus 200a may first be communicatively connected to the terminal device 300a through a wireless network, such as the transceiver 2303 and the like. The terminal device 300a may be communicatively connected to the external or local cloud computing platform or server 400a, thereby enabling the near-to-eye display apparatus 200a to be communicatively connected to the external or local cloud computing platform or server 400a. The near-to-eye display apparatus 200a, the (external) terminal device 300a, and the server 400a may each be configured to store and process content data received or uploaded by the near-to-eye display apparatus 200a. In some embodiments, the near-to-eye display apparatus 200a may be directly communicatively connected to the server 400a through a wireless or wired network. The near-to-eye display apparatus 200a may be a portable and movable lightweight device, such as smart glasses or an augmented reality device. The near-to-eye display apparatus 200a may include the near-to-eye display module 100a. The terminal device 300a may be a smartphone, a laptop computer, a tablet computer, or a desktop computer. In some embodiments, multiple near-to-eye display apparatuses 200a may be communicatively connected to each other. In some embodiments, the near-to-eye display apparatus 200a may further be communicatively connected to a wearable interactive device, such as a smart ring, a smart wristband, a smart handle, or the like, through which the interactive operation on the near-to-eye display apparatus 200a may be implemented, such as page turning, page scrolling, selection, confirmation, or the like.

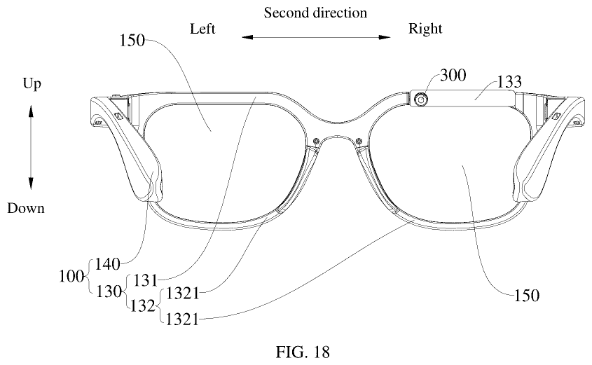

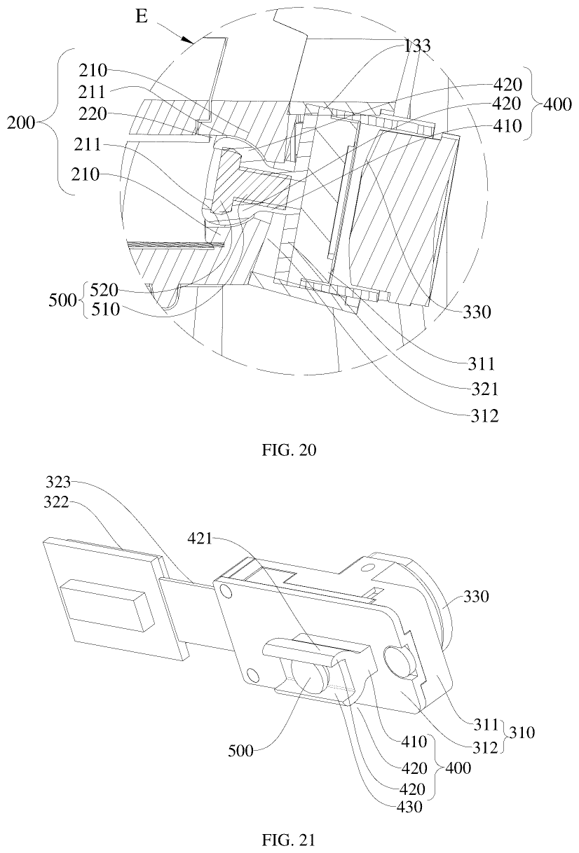

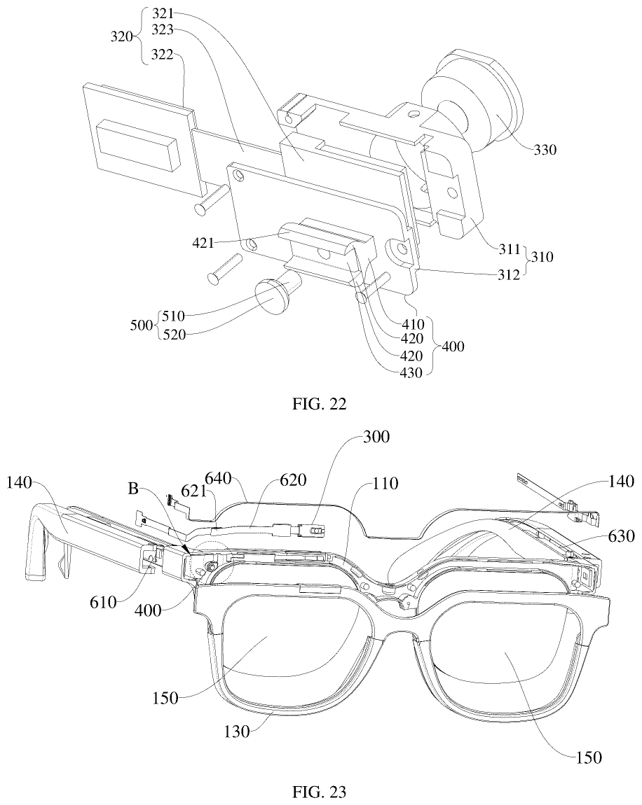

As shown in FIGS. 18-30, a near-to-eye display device according to some embodiments of the present disclosure may be described. The near-to-eye display device may include a device body 100, a near-to-eye display mechanism 300, a locking mechanism 500, and a camera module 700. The device body 100 may have a near-to-eye side C and an environment side D. It should be noted that, in some embodiments, a first direction of the device body 100 may be a direction from the near-to-eye side C to the environment side D. The first direction may be understood as a longitudinal direction in a front-rear direction of the device body 100. A second direction of the device body 100 may be a direction perpendicular to the first direction. The second direction may be understood as a transverse direction in a left-right direction of the device body 100.

As shown in FIGS. 18-22, in some embodiments of the present disclosure, a first connection structure 200 may be disposed in the device body 100. The near-to-eye display mechanism 300 may be configured to generate light and project the light to human eyes. A second connection structure 400 may be disposed in the near-to-eye display mechanism 300. The first connection structure 200 may be movably connected to the second connection structure 400. The locking mechanism 500 may be movably connected to the second connection structure 400. The locking mechanism 500 may be configured to move relative to the second connection structure 400 and may at least have a first position and a second position. In a case where the locking mechanism 500 is in the first position, the locking mechanism 500 may be configured to act on the second connection structure 400 to lock a relative position between the first connection structure 200 and the second connection structure 400. In a case where the locking mechanism 500 is in the second position, the locking mechanism 500 may be configured to release its action on the second connection structure 400, and the first connection structure 200 and the second connection structure 400 may move relative to each other, enabling adjustment of an angle between the near-to-eye display mechanism 300 and the device body 100. By providing the device body 100 with the first connection structure 200, providing the near-to-eye display mechanism 300 with the second connection structure 400, movably connecting the first connection structure 200 with the second connection structure 400, and fixedly cooperating the locking mechanism 500 with the second connection structure 400, the user may fix or adjust the angle between the near-to-eye display mechanism 300 and the device body 100 through an operation position of the locking mechanism 500, thereby realizing angle adjustment at different angles and meeting viewing requirements of the user.

It can be understood that, as shown in FIGS. 18-20 and FIG. 23, in some embodiments of the present disclosure, the device body 100 may include a spectacle frame 130 and two temples 140. The spectacle frame 130 may be configured to mount lenses 150. The two temples 140 may be respectively connected to two sides of the spectacle frame 130. A cavity 110 may be defined in the spectacle frame 130. The locking mechanism 500 and the first connection structure 200 may be both disposed inside the cavity 110. The near-to-eye display mechanism 300A and a part of the second connection structure 400 may be disposed outside the cavity 110. Another part of the second connection structure 400 may extend into the cavity 110. It can be understood that the spectacle frame 130 may be located at the environment side D. A through hole may be defined at a position of the spectacle frame 130 corresponding to the first connection structure 200, the second connection structure 400, or the locking mechanism 500, thereby allowing the user to adjust the locking mechanism 500 using a tool or a hand to realize a movable connection between the first connection structure 200 and the second connection structure 400. In some other embodiments, adjustment of the locking mechanism 500 may be performed from the near-to-eye side C.

By adopting the above structure, the cavity 110 may provide an appropriate space for various components, allowing the respective connection structures and components to be accommodated therein. The distribution of components inside and outside the cavity 110 may be reasonable, which not only ensures overall structural compactness, but also enables key components to be appropriately protected and isolated, thereby ensuring functionality and stability of the device.

It should be noted that, in some embodiments, an operation recess or through hole that is in communication with the cavity 110 may be defined on a front side of the spectacle frame 130 in the first direction. A cover may be detachably disposed in the operation recess. In a normal state in which adjustment is not required, the cover may be configured to shield the recess or through hole at the position of the spectacle frame corresponding to the first connection structure 200, the second connection structure 400, or the locking mechanism 500. The operation recess or through hole may correspond to the locking mechanism 500. Through removing the cover from the spectacle frame 130, the locking mechanism 500 inside the cavity 110 may be operated. After finishing operating the locking mechanism 500, the cover may be snapped into the operation recess of the spectacle frame 130. The above structure may be simple, disassembly and assembly may be convenient, and user operation of the locking mechanism 500 to adjust the near-to-eye display mechanism 300 may be facilitated.

In some embodiments, as shown in FIGS. 18-22, in some embodiments of the present disclosure, the first connection structure 200 may be inserted into or plug-fitted with and rotatably connected to the second connection structure 400. The device body 100 may have the near-to-eye side C and the environment side D. The locking mechanism 500 may be disposed on a side of the spectacle frame 130 of the device body 100 away from the near-to-eye side C. In a case where the locking mechanism 500 moves to the first position, the locking mechanism 500 may be configured to act on the second connection structure 400, and the first connection structure 200 and the second connection structure 400 may be pressed against each other and fixed relative to each other. In a case where the locking mechanism 500 moves to the second position, the locking mechanism 500 may be configured to release its action on the second connection structure 400. In this case, a gap may exist between the first connection structure 200 and the second connection structure 400, and a relative rotation between the first connection structure 200 and the second connection structure 400 may be allowed, enabling adjustment of the angle of the near-to-eye display mechanism 300 relative to the spectacle frame 130 of the device body 100.

By adopting the above structure, in a case where the locking mechanism 500 moves to the first position, the locking mechanism 500 may be configured to apply an action to the second connection structure 400, thereby pressing and fixing the first connection structure 200 and the second connection structure 400 relative to each other. Such fixing action may ensure a stable connection between the first connection structure 200 and the second connection structure 400 and reduce unnecessary movement therebetween. In a case where the locking mechanism 500 moves to the second position, the locking mechanism 500 may be configured to release the fixing action on the second connection structure 400, allowing the gap to exist between the first connection structure 200 and the second connection structure 400, such that the first connection structure 200 and the second connection structure 400 may rotate relative to each other with a certain clearance. Accordingly, the user may adjust the angle of the near-to-eye display mechanism 300 relative to the spectacle frame 130 of the device body 100 through adjusting a relative position between the first connection structure 200 and the second connection structure 400, thereby structurally realizing fixing and angle adjustment functions. Through the locking and unlocking mechanism, the user may conveniently adjust the angle of the near-to-eye display mechanism 300 relative to the device body 100 to achieve a desirable visual experience and wearing comfort.

As shown in FIGS. 18-22, in some embodiments of the present disclosure, the first connection structure 200 and the second connection structure 400 may be in sliding engagement. In a case where the locking mechanism 500 is in the first position, the locking mechanism 500 may be configured to act on the second connection structure 400 to restrict relative sliding between the second connection structure 400 and the first connection structure 200. In a case where the locking mechanism 500 is in the second position, the locking mechanism 500 may be configured to release its action on the second connection structure 400, and the second connection structure 400 and the first connection structure 200 may be able to slide relative to each other.

By adopting the above structure, the first connection structure 200 and the second connection structure 400 may be able to, in addition to the relative rotation, slide relative to each other. Similarly, through the locking and unlocking mechanism, the user may conveniently adjust the position of the near-to-eye display mechanism 300 relative to the spectacle frame 130 of the device body 100, thereby achieving better visual experience and wearing comfort.

Apparently, in some embodiments, the first connection structure 200 and the second connection structure 400 described above may only be rotatably fitted or in rotatable engagement and may not be slidably fitted, which is not limited herein.

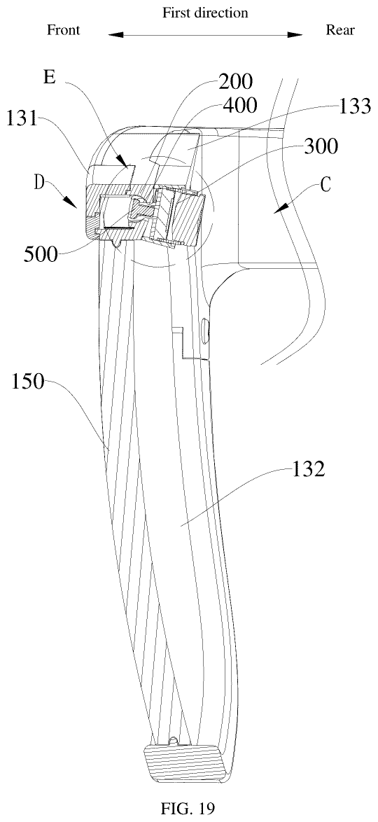

It can be understood that, as shown in FIGS. 19-22, in some embodiments of the present disclosure, the first connection structure 200 may include an abutting wall 210. One end of the abutting wall 210 may be connected to an inner wall of the cavity 110 of the device body 100. A mounting position 220 may be formed on the abutting wall 210. The second connection structure 400 may include a base body 410 and an expansion portion 420. The base body 410 may be connected to the near-to-eye display mechanism 300. The expansion portion 420 may be connected to a side of the base body 410 away from the near-to-eye display mechanism 300. A mounting groove 430 may be formed between the expansion portion 420 and the base body 410. The expansion portion 420 may be inserted into the mounting position 220. The expansion portion 420 may be configured to correspondingly cooperate with the abutting wall 210. The locking mechanism 500 may be movably connected to the base body 410. The locking mechanism 500 may be disposed in the mounting groove 430. The locking mechanism 500 may be configured to drive the expansion portion 420 to expand relative to the base body 410 and to abut against the abutting wall 210.

Through the above arrangement, the expansion portion 420 may be inserted into the mounting position 220 of the abutting wall 210 and may be configured to correspondingly cooperate with the abutting wall 210, thereby ensuring the stable connection between the first connection structure 200 and the second connection structure 400. The movement of the locking mechanism 500 may control movement of the expansion portion 420, such that the user may adjust both the angle and the position of the near-to-eye display mechanism 300 relative to the device body 100. The above design may provide flexibility, enabling the user to adjust the angle of the device according to personal needs and comfort, thereby improving user experience. Requirements for both fixation and adjustability may be satisfied. Through the action of the locking mechanism 500, the connection structures may be fixed when needed to maintain stability, and when angle adjustment is required, the locking mechanism 500 may be released to achieve flexible angle adjustment. The user may control and adjust the expansion portion 420 through simple operations, such as actuating the locking mechanism 500, without requiring complex tools or operating procedures.

As shown in FIGS. 19-22, in some embodiments of the present disclosure, the locking mechanism 500 may include a connecting portion 510 and a driving portion 520 connected to the connecting portion 510. The connecting portion 510 may be movably connected to the base body 410. The driving portion 520 may be configured to move along with the connecting portion 510, so as to move into the mounting groove 430 and to expand the expansion portion 420 to abut against the abutting wall 210. The driving portion 520 may further be configured to move along with the connecting portion 510, so as to move out of the mounting groove 430 and space the expansion portion 420 apart from the abutting wall 210.

Through the above configuration, releasing and adjustable functions may be achieved, such that locking and releasing operations may be conveniently performed. The user may control the driving portion 520 through simple operations to achieve movement of the connecting portion 510 and functional switching, without requiring complicated operations or tools. In this way, flexibility may be provided, so that the user may selectively choose between a locked state or a released state as required, so as to realize fixation or adjustment between the first connecting structure 200 and the second connecting structure 400.

It should be noted that, in some embodiments, the locking mechanism 500 may be a locking bolt. That is, the connecting portion 510 may be a threaded rod portion of the locking bolt and may be in threaded engagement with the base body 410. The driving portion 520 may be a head portion of the locking bolt. Apparently, in some embodiments, the locking mechanism 500 may have another structure, for example, the locking mechanism 500 may be a snap-fitting member that is capable of being snapped to the base body 410, which is not limited herein.

As shown in FIGS. 19-22, in some embodiments of the present disclosure, a first arcuate surface 211 may be formed on an inner side surface of the abutting wall 210. A second arcuate surface 421 may be formed on a side of the expansion portion 420 away from the mounting groove 430. The first arcuate surface 211 and the second arcuate surface 421 may correspondingly cooperate with each other. A width of the driving portion 520 may be greater than a minimum spacing of the mounting groove 430.

With the above structure, the first arcuate surface 211 and the second arcuate surface 421 may be cooperatively configured, thereby ensuring stability of connection and correct positioning, such that relative rotation or sliding between the first connecting structure 200 and the second connecting structure 400 may be relatively smooth and stable. Since the driving portion 520 has a relatively large width, in a case where the driving portion 520 moves along with the connecting portion 510, the driving portion 520 may be squeezed into a position of the mounting groove 430 that has the minimum spacing. The driving portion 520 may be further configured to push the expansion portion 420 to abut against and be tightly pressed against the abutting wall 210, or may be further configured to move away from the mounting groove 430 to restore the state of the expansion portion 420. The above configuration of the width of the driving portion 520 corresponding to the spacing of the mounting groove 430 may firmly control the position of the expansion portion 420, thereby providing a desirable positioning and operational stability, and ensuring accuracy and firmness of connection.

As shown in FIGS. 19-22, in some embodiments of the present embodiment, the number of the expansion portion 420 may be two. The two expansion portions 420 may face away from the near-to-eye side C. The expansion portions 420 may extend along a second direction; the mounting position 220 may be located between the near-to-eye side C and the environment side D. The number of the abutting wall 210 may be two. The mounting position 220 may be formed by the two abutting walls 210. The mounting position 220 may be located between the near-to-eye side C and the environment side D. The mounting position 220 may extend along the second direction. The two expansion portions 420 may respectively correspond to and cooperate with the two abutting walls 210. The expansion portions 420 may be slidably connected to the mounting position 220 along the second direction. Through the above structure, installation stability between the first connecting structure 200 and the second connecting structure 400 may be further improved.

Apparently, in some embodiments, the number of the expansion portion 420 and the number of the abutting wall 210 may each be one, three, or the like, which is not limited herein.

It may be understood that, as shown in FIGS. 23-25, in some embodiments, the near-to-eye display device may further include a control circuit board 610 and a first conductive wire 620. The control circuit board 610 may be disposed on the temple 140. The near-to-eye display mechanism 300 may be electrically connected to the control circuit board 610 through the first conductive wire 620. A positioning structure 120 may be disposed in the cavity 110. The first conductive wire 620 may be disposed in the cavity 110. The first conductive wire 620 may be wound around and cooperatively arranged with the positioning structure 120. The near-to-eye display mechanism 300 may be configured to move toward the positioning structure 120 and enable the first conductive wire 620 to be bent to form a stacked segment 621. The stacked segment 621 may be located between the positioning structure 120 and the near-to-eye display mechanism 300. With the above structure, since the first conductive wire 620 is first bent around the positioning structure 120 and then form the stacked segment 621 at the positioning structure 120, the first conductive wire 620 may have a certain redundant length, thereby allowing the first conductive wire 620 to slide laterally along the second direction, reducing damage during lateral sliding of the first conductive wire 620, and improving durability.

As shown in FIGS. 23-25, in some embodiments of the present disclosure, the near-to-eye display device may further include a first battery 630 and a second conductive wire 640. The control circuit board 610 may be disposed on one of the temples 140. The first battery 630 may be disposed on the other one of the temples 140. The second conductive wire 640 may be disposed in the cavity 110. One end of the second conductive wire 640 may be electrically connected to the control circuit board 610, and another end of the second conductive wire 640 may be electrically connected to the first battery 630.

With the above structure, it may be understood that the cavity 110 may extend across left visual field and right visual field of the frame 130, the second conductive wire 640 may be disposed in the cavity 110 and may respectively be electrically connected to the control circuit board 610 and the first battery 630. In this way, the internal space of the frame 130 may be fully utilized, allowing the second conductive wire 640 to be orderly arranged within the cavity 110, reducing disorder and exposure of the second conductive wire 640, and providing effective protection. Further, interference from the external environment to the second conductive wire 640 may be reduced, improving overall structural reliability and durability, and ensuring stability and reliability of signal transmission.

As shown in FIGS. 19-24, in some embodiments of the present disclosure, the near-to-eye display mechanism 300 may further include a mounting assembly 310, a display module 320, and the optical module 330 disposed on one side of the display module 320. The display module 320 and the optical module 330 may both be disposed on the mounting assembly 310. The display module 320 may be configured to generate light. The optical module 330 may be configured to receive light from the display module 320 and project the light to the human eye. The second connecting structure 400 may be disposed on a side of the mounting assembly 310 away from the optical module 330. The display module 320 may be electrically connected to the control circuit board 610 through the first conductive wire 620. Through the above configuration, in a case where the display module 320 moves toward a position of the positioning structure 120, the stacked segment 621 formed by flattening and folding of the first conductive wire 620 due to the positioning structure 120 may reduce excessive bending and entanglement of the first conductive wire 620, which facilitates reducing damage to the first conductive wire 620 during lateral sliding.

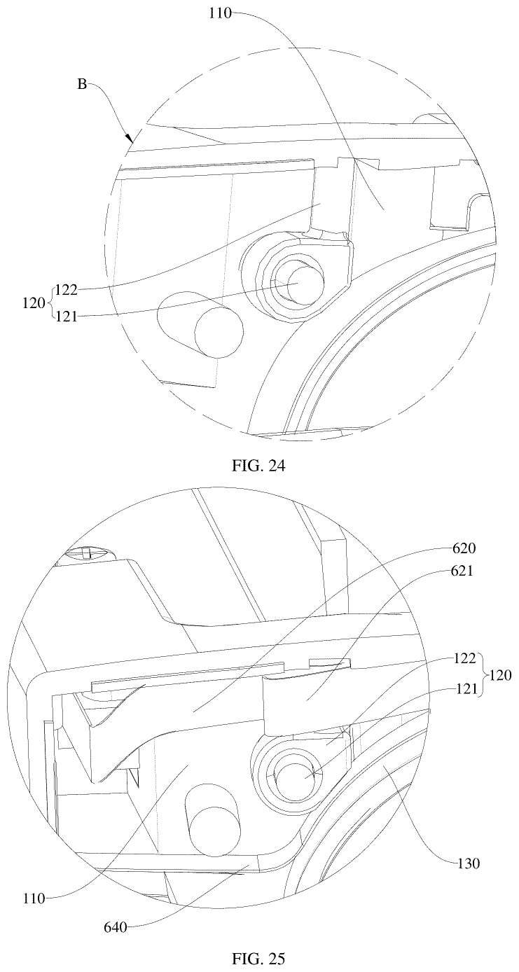

It should be noted that, as shown in FIG. 23 and FIG. 24, in some embodiments of the present disclosure, the positioning structure 120 may include a first positioning post 121 and a second positioning post 122. The first positioning post 121 may be located below the second positioning post 122. A transition block may be disposed on one end of the second positioning post 122. The transition block may be sleeved on the first positioning post 121. A wire-passing gap may be defined between the second positioning post 122 and the inner wall of the cavity 110. In this way, the first conductive wire 620 may pass through the wire-passing gap and overlap around the second positioning post 122 to form the stacked segment 621. The stacked segment 621 may be located on a side of the second positioning post 122 away from the wire-passing gap. An upper surface of the transition block may support a bottom of the first conductive wire 620. Apparently, in some embodiments, the positioning structure 120 may include only the second positioning post 122. In this case, the second positioning post 122 may be formed by extending downward from an upper wall of the cavity 110 of the frame 130, such that the transition block and the first positioning post 121 may not be required.

As shown in FIG. 23 and FIG. 24, in some embodiments of the present disclosure, the mounting assembly 310 may include a base 311 and a cover plate 312. The cover plate 312 may be connected to the base 311. The optical module 330 may be disposed on the base 311. The second connecting structure 400 may be disposed on the cover plate 312. The display module 320 may include a micro display 321, a driving board 322, and a third conductive line 323, the micro display 321 may be disposed between the base 311 and the cover plate 312, the driving board 322 may be electrically connected to the micro display 321 through the third conductive line 323, and the driving board 322 may be electrically connected to the control circuit board 610 through the first conductive wire 620.

With the above structure, the optical module 330 and the second connecting structure 400 may be respectively disposed on different components, which may facilitate maintenance and replacement. The micro display 321 may be disposed between the base 311 and the cover plate 312. Electrical connections among the respective modules may be realized through conductive wires, which enables a reasonable module layout, a stable and reliable connection, etc., thereby providing effective assurance for functionality and reliability of the device.

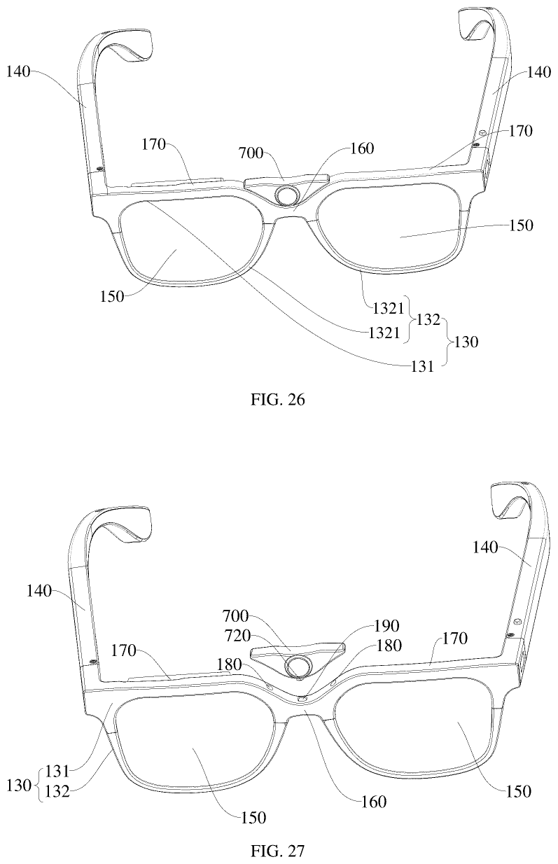

It may be understood that, as shown in FIGS. 26-29, in some embodiments of the present disclosure, a first installation area 160 and a second installation area 170 may be formed on the frame 130 of the device body 100. The first installation area 160 and the second installation area 170 may be spaced apart from each other. The second installation area 170 may be configured to install the lenses 150. The near-to-eye display mechanism 300 may be disposed in the second installation area 170. The near-to-eye display mechanism 300 may be configured to generate light and project the light toward the near-to-eye side C. The camera module 700 may be configured to be detachably connected to the first installation area 160 of the device body 100. In a case where the camera module 700 is located in the first installation area 160, the camera module 700 may face the environment side D away from the near-to-eye side C and be configured to obtain an image of the environment side D. The camera module 700 may not overlap with the lens 150 in the first direction.

Some embodiments of the present disclosure may provide the near-to-eye display device, in which the device body 100 may be divided into the first installation area 160 and the second installation area 170, thereby realizing a clear division of installation areas for different components. The first installation area 160 may be configured to install the camera module 700. The second installation area 170 may be configured to install the lenses 150 and the near-to-eye display mechanism 300. By detachably installing the camera module 700 in the first installation area 160 of the device body 100, installation and removal may be facilitated, which may be convenient for maintenance, replacement, or upgrading. The above detachable connection design may provide flexibility and convenience, and may help mitigate an overly abrupt visual appearance.

As shown in FIGS. 26-29, in some embodiments of the present disclosure, the near-to-eye display mechanism 300 may not overlap with the lenses 150 in the first direction. The near-to-eye display mechanism 300 may be located between the near-to-eye side C and the environment side D. The number of the second installation area 170 may be two. The two second installation areas 170 may be respectively located on two sides of the first installation area 160. A height of the first installation area 160 may be lower than a height of the second installation areas 170. The near-to-eye display mechanism 300 may be disposed on at least one second installation area 170. An installation cover 133 may be disposed on the frame 130 of the device body 100 corresponding to the second installation area 170. An installation cavity may be defined between a housing 730 and the second installation area 170. The display module 320 of the near-to-eye display mechanism 300 may be disposed in the installation cavity. An end portion of the optical module 330 may extend to an end surface of the installation cover 133. A recess extending along the second direction may be defined on the first installation area 160. A protrusion adapted to a shape of the recess may be formed on the camera module 700. With the above structure, a certain protective effect on the near-to-eye display mechanism 300 may be achieved to reduce exposure. In addition, a visual balance and symmetrical aesthetic design may be realized through the recess of the first installation area 160 and the protrusion of the camera module 700, which may help mitigate the overly abrupt visual appearance and achieve a concealed effect.

As shown in FIGS. 26-29, in some embodiments of the present disclosure, the first installation area 160 may be located at a middle portion of the frame 130 of the device body 100. A magnetic attraction structure may be formed between the device body 100 and the camera module 700. The magnetic attraction structure may include a first magnetic attraction portion 180 and a second magnetic attraction portion 710. The first magnetic attraction portion 180 may be disposed on the frame 130 of the device body 100 and may be located at the first installation area 160. The second magnetic attraction portion 710 may be disposed on the camera module 700. The first magnetic attraction portion 180 and the second magnetic attraction portion 710 may be correspondingly arranged and may be configured to attract each other.

Through the above configuration, the first magnetic attraction portion 180 and the second magnetic attraction portion 710 may be configured to attract each other to provide a stable connection manner. The above design may enable a convenient and fast installation and removal, while ensuring stability and reliability of the connection, thereby providing a better user experience.

As shown in FIGS. 26-29, in some embodiments of the present embodiment, the first magnetic attraction portion 180 and the second magnetic attraction portion 710 may be magnets with opposite magnetic polarities. Alternatively, one of the first magnetic attraction portion 180 and the second magnetic attraction portion 710 may be a magnet, and the other one of the first magnetic attraction portion 180 and the second magnetic attraction portion 710 may be an iron component. The number of the first magnetic attraction portion 180 may be two. The two first magnetic attraction portions 180 may be spaced apart from each other along the second direction in the first installation area 160. The number of the second magnetic attraction portion 710 may be two. The two second magnetic attraction portions 710 may be spaced apart from each other and respectively disposed on two opposite sides of the camera module 700. Through the use of the magnets with opposite magnetic polarities or a combination of the magnet and the iron component, the connection structure may be relatively flexible and reliable, connection between the frame 130 of the device body 100 and the camera module 700 may be quickly completed. In this case, disassembly and maintenance may be facilitated while maintaining stability. The arrangement of two first magnetic attraction portions 180 and the two second magnetic attraction portions 710 at intervals along the specified direction may help ensure stability and balance of the connection, and may reduce deviation and instability during the connection process.

Apparently, in some embodiments, the number of the first magnetic attraction portion 180 and the number of the second magnetic attraction portion 710 may each be one, three, or the like, which is not limited herein.

As shown in FIGS. 26-29, in some embodiments, a fixing structure may be provided between the camera module 700 and the device body 100. The fixing structure may include a first fixing portion 190 and a second fixing portion 720. The first fixing portion 190 may be disposed on the device body 100 and may be located at the first installation area 160. The second fixing portion 720 may be disposed on the camera module 700. The first fixing portion 190 and the second fixing portion 720 may be correspondingly arranged and may be plug-fitted with each other. One of the first fixing portion 190 and the second fixing portion 720 may be a fixing groove, and the other one of the first fixing portion 190 and the second fixing portion 720 may be a fixing protrusion. The fixing protrusion may be plug-fitted with the fixing groove.

With the above structure, through a plug-fitting cooperation between the fixing groove and the fixing protrusion, the structure may be simple and convenient for manufacturing, and a stable connection may be realized. In this way, installation between the frame 130 of the device body 100 and the camera module 700 may be relatively firm and reliable, thereby providing better stability and reliability during use of the device.

As shown in FIG. 29, the frame 130 may further include a first connecting member 810 and a second connecting member 820. The first connecting member 810 and the second connecting member 820 may be configured to cooperate with each other, for enabling a detachable connection between an upper frame body 131 and a lower frame body 132.

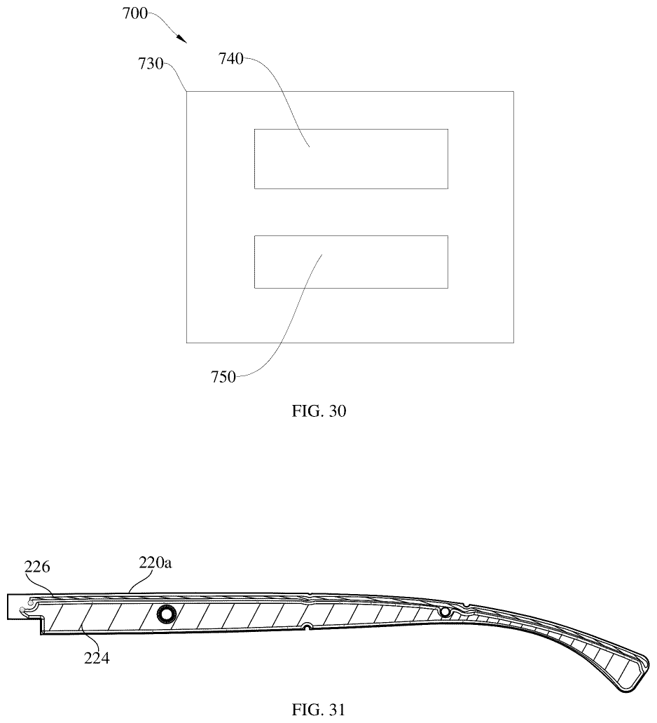

It may be understood that, as shown in FIG. 30, in some embodiments of the present disclosure, the camera module 700 may include the housing 730, an image sensing unit 740, and a second battery 750. The second battery 750 may be electrically connected to the image sensing unit 740. The second battery 750 may not be electrically connected to the control circuit board 610 and the first battery 630, i.e., the second battery 750 may be electrically isolated from the control circuit board 610 and the first battery 630, such that the camera module 700 may be configured to operate independently.

In some other embodiments, the camera module 700 may include the housing 730, the image sensing unit 740, and a first electrical interface. A second electrical interface may be further disposed on the first installation area 160. In a case where the camera module 700 is disposed in the first installation area 160, the first electrical interface and the second electrical interface may be electrically connected to each other, so as to enable the image sensing unit 740 to be electrically connected to the control circuit board 610 and the first battery 630. In this way, the camera module 700 may be detachably and electrically connected to other electrical components in the cavity 110 of the frame 130, thereby enabling interconnection among the respective modules.

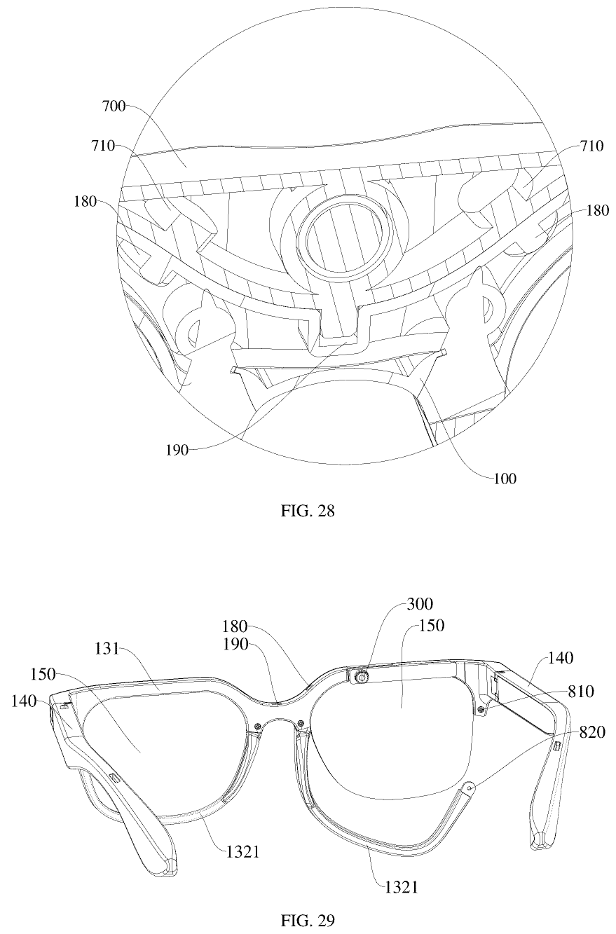

As shown in FIG. 27 and FIG. 28, in some embodiments of the present disclosure, the frame 130 may include the upper frame body 131 and the lower frame body 132 connected to the upper frame body 131. The upper frame body 131 and the lower frame body 132 may cooperate to form two second installation areas 170. The first installation area 160 may be disposed at a middle portion of the upper frame body 131. A part of the lower frame body 132 may be rotatably connected to the upper frame body 131, and another part of the lower frame body 132 may be detachably connected to the upper frame body 131. The lower frame body 132 may include two lower frame members 1321. For each of the two lower frame members 1321, one end of the lower frame member 1321 may be rotatably connected to the upper frame body 131, and another end of the lower frame member 1321 may be detachably connected to the upper frame body 131. Each lower frame member 1321 and a corresponding part of the upper frame body 131 may jointly enclose a region for installing the lens 150. Through the above configuration, the upper frame body 131 and the lower frame body 132 may form a semi-open structure, thereby facilitating replacement of the lens 150 by the user.

It should be noted that, in some embodiments, a front frame and a rear frame of the frame 130 may form the upper frame body 131. The rotation connection and opening manner between the upper frame body 131 and the lower frame body 132 may be reversible between left and right.

The above descriptions are merely some embodiments of the present disclosure and are not intended to limit the patent scope of the present disclosure. Any equivalent structures or equivalent process transformations made by using the contents of the specification and drawings of the present disclosure, or any direct or indirect application thereof in other related technical fields, shall fall within the patent protection scope of the present disclosure.

1. A near-to-eye display apparatus, comprising:
a frame, defining a first cavity;
a near-to-eye display module, disposed on the frame;
a first limiting portion, connected to the frame, wherein the first limiting portion defines a first through hole, and the first through hole is in communication with the first cavity;
a first temple, defining a second cavity;
a first electrical device, disposed in the second cavity;
a second limiting portion, connected to the first temple, wherein the second limiting portion defines a second through hole, the second limiting portion is rotatably connected to the first limiting portion, the second through hole is in communication with the second cavity, and the first through hole is in communication with the first cavity;
a first conductive line, passing through the first through hole and the second through hole, and electrically connected to the near-to-eye display module and the first electrical device;
a second temple, defining a third cavity, wherein the second temple is rotatably connected to the frame;
a second electrical device, disposed in the third cavity; and
a second conductive line, extending laterally along the frame, wherein the second conductive line passes through the first through hole and the second through hole and the second conductive line is electrically connected to the second electrical device and the first electrical device.

2. The near-to-eye display apparatus as claimed in claim 1, wherein a length of the first conductive line is smaller than a length of the second conductive line, the near-to-eye display module is configured to be movable on the frame, the first conductive line is configured to at least partially move within the first cavity in a case where the near-to-eye display module moves relative to the frame, the second conductive line is disposed in the frame and remains fixed, and portions of the first conductive line and the second conductive line that overlap with each other in an extension direction are electrically insulated from each other.

3. The near-to-eye display apparatus as claimed in claim 2, wherein a first snap hole is defined on the first conductive line, a second snap hole is defined on the second conductive line, the number of the second snap hole is at least two and the at least two second snap holes are spaced apart from each other, at least two snap posts are disposed on the frame, and the first snap hole and the second snap holes are respectively connected to the snap posts.

4. The near-to-eye display apparatus as claimed in claim 1, further comprising a rotating shaft;
wherein the rotating shaft is rotatably connected to at least one of the second limiting portion or the first limiting portion, and a third through hole is defined on the rotating shaft;
the first cavity, the first through hole, the third through hole, and the second cavity are in communication with each other, the first conductive line and the second conductive line are configured to pass through the third through hole, and the rotating shaft is configured to drive the first conductive line and the second conductive line to rotate synchronously.

5. The near-to-eye display apparatus as claimed in claim 4, further comprising a fastener;
wherein the first limiting portion comprises a first connecting segment, the first connecting segment defines a fourth through hole, the second limiting portion comprises a second connecting segment, the second connecting segment defines a fifth through hole, the rotating shaft defines a fixing hole, and the fastener is configured to pass through the fourth through hole and the fifth through hole and to be connected to the fixing hole.

6. The near-to-eye display apparatus as claimed in claim 5, wherein the number of the first connecting segment is two and the two first connecting segments are disposed opposite to each other, the number of the second connecting segment is two and the two second connecting segments are disposed opposite to each other, the number of the fastener is two and the two fasteners are disposed opposite to each other;
the second connecting segments are disposed between the two first connecting segments, the rotating shaft is disposed between the two second connecting segments, each of the two fasteners is connected to a corresponding one of the two second connecting segments and a corresponding one of the two first connecting segments;
the first conductive line and the second conductive line are located between the two fasteners, and the first conductive line and the second conductive line are respectively spaced apart from the fasteners.

7. The near-to-eye display apparatus as claimed in claim 5, wherein the rotating shaft comprises a first shaft segment and a second shaft segment, each of the first shaft segment and the second shaft segment comprises an annular segment, an extension segment, and a fixing segment;
the fixing hole is defined in the annular segment, the extension segment and the fixing segment respectively extend in directions away from the annular segment and are spaced apart from each other around a circumference of the fixing hole;
a connection hole is defined on the extension segment, the fixing segment of the first shaft segment is connected to the connection hole of the extension segment of the second shaft segment, and the connection hole of the extension segment of the first shaft segment is connected to the fixing segment of the second shaft segment.

8. The near-to-eye display apparatus as claimed in claim 5, wherein two oppositely arranged connection slots are defined on the frame, the first limiting portion further comprises a first limiting main body and a first protruding part, the first protruding part and the first connecting segment are respectively located at two ends of the first limiting main body;
the first protruding part extends toward a side away from the first connecting segment, the number of the first protruding part is two, and the two first protruding parts are respectively fixedly connected to the two connection slots.

9. The near-to-eye display apparatus as claimed in claim 8, wherein the first protruding part comprises periodically arranged protrusions extending away from the first limiting main body, at least one through hole is defined on the first protruding part, and the through hole is configured to accommodate adhesive.

10. The near-to-eye display apparatus as claimed in claim 3, wherein the near-to-eye display module comprises a first sliding portion, the frame comprises a second sliding portion configured to cooperate with the first sliding portion, the near-to-eye display module is configured to move in a direction toward the first temple and to bend the first conductive line, and the near-to-eye display module is further configured to move in a direction away from the first temple and to expand the first conductive line.

11. The near-to-eye display apparatus as claimed in claim 10, wherein the near-to-eye display module further comprises:
a first housing, defining a first accommodating cavity;
a micro-display assembly, disposed in the first accommodating cavity and configured to generate light;
an optical element, disposed on the first housing and located at a light-emitting side of the micro-display assembly, wherein light generated from the micro-display assembly is configured to enter a first end of the optical element and exit from a second end of the optical element;
a damping rotation mechanism, disposed between the first housing and the first sliding portion, wherein the damping rotation mechanism is rotatably connected to the first housing, and the first housing is configured to perform a damping rotation relative to the frame through the damping rotation mechanism and to maintain the optical element emitting light at an expected fixed angle relative to the frame.

12. The near-to-eye display apparatus as claimed in claim 11, wherein a first hole is defined on the first housing, the damping rotation mechanism comprises a locking member and a bushing, the locking member is configured to insert through the bushing and to be fixed in the first hole, the first sliding portion is connected to an outer periphery of the bushing, and the first sliding portion extends in a direction away from the locking member.

13. The near-to-eye display apparatus as claimed in claim 12, wherein the damping rotation mechanism further comprises a first spacer and a second spacer, the locking member is configured to insert through the bushing, the first spacer, and the second spacer and to be fixed in the first hole;
wherein the first spacer and the second spacer are respectively located at two sides of the bushing, or the first spacer and the second spacer are both located at a same side of the bushing.

14. The near-to-eye display apparatus as claimed in claim 13, wherein a protruding portion is further disposed on the first housing, the bushing is at least partially sleeved on the protruding portion, and an extending length of the first sliding portion is smaller than a radial size of the optical element.

15. The near-to-eye display apparatus as claimed in claim 11, wherein the near-to-eye display module further defines a first center plane passing through a central rotation axis of the damping rotation mechanism, the optical element defines a second center plane, a rotation angle of the second center plane relative to the first center plane is in a range of 0°-25°, and a moving distance of the first housing relative to the frame is in a range of 0 cm-1 cm.

16. The near-to-eye display apparatus as claimed in claim 11, wherein the optical element further comprises:
a light incident surface, located at the first end;
a first reflective surface, located at the second end opposite to the first end;
a second reflective surface, located at the first end, wherein the second reflective surface surrounds the light incident surface; and
a light exit surface, located at the second end, wherein the light exit surface surrounds the first reflective surface, the micro-display assembly faces toward the light incident surface, and a second optical element faces toward the light exit surface;
wherein a chamfer is disposed on an outer periphery of the light incident surface, and the light incident surface is eccentrically arranged relative to the second reflective surface.

17. The near-to-eye display apparatus as claimed in claim 16, wherein the light incident surface, the first reflective surface, the second reflective surface, and the light exit surface comprise free-form surfaces and are generated by a same continuous function, and an outer contour of a projected area of the optical element onto the micro-display assembly substantially comprises a circular shape or an elliptical shape.

18. The near-to-eye display apparatus as claimed in claim 15, wherein the near-to-eye display module further comprises a barrel, a flange is further disposed on the first housing, the optical element is disposed in the barrel, and the barrel is movably connected to the flange and is configured to adjust a distance between the optical element and the micro-display assembly.

19. The near-to-eye display apparatus as claimed in claim 10, wherein the micro-display assembly comprises a micro display, a third conductive line, and a first electrical interface that are electrically connected to each other, the micro display and the optical element are aligned with each other, the third conductive line is connected between the micro display and the first electrical interface;
a second electrical interface is disposed on the first conductive line, the second electrical interface and the first electrical interface are electrically plugged and connected with each other; and
the near-to-eye display apparatus further comprises a sealing plate, the sealing plate is connected to the frame and is configured to seal the first cavity.

20. The near-to-eye display apparatus as claimed in claim 1, wherein the near-to-eye display apparatus further comprises a fixing block, the fixing block is fixed in the first cavity, and the second sliding portion is disposed on the fixing block;
the near-to-eye display apparatus further comprises a lens disposed on the frame, a scale marking is disposed on a side of the first housing facing a human eye; and
the frame further comprises an upper frame located away from the lens, and a rotation range of the first housing toward the lens is greater than a rotation range of the first housing toward the upper frame.
